(19) United States
(12) Patent Application Publication
(10) Pub. No.: US 2025/0353454 A1
(43) Pub. Date: Nov. 20, 2025

(54) POWER NETWORK ARCHITECTURE FOR VEHICLES

(71) Applicant: Daimler Truck North America LLC, Portland, OR (US)

(72) Inventors: Kieran LEE, Portland, OR (US); Thomas L’ESTRANGE, Portland, OR (US); Justin WANG, Portland, OR (US); Kevin DOANE, Portland, OR (US); Kurtis Alexander WENDLING, Portland, OR (US); Coleman BOYD, Portland, OR (US); Robert HEYBURN, Portland, OR (US); Nandesh MUTHUPRAKASH, Portland, OR (US)

(21) Appl. No.: 19/211,018

(22) Filed: May 16, 2025

(30) Foreign Application Priority Data
May 17, 2024 (IN) 202421039036

(51) Int. Cl. B60R 16/023; B60R 16/033; G07C 5/08

(52) U.S. Cl. CPC B60R 16/0238; B60R 16/033; G07C 5/0816

(57) ABSTRACT

Aspects relate to a power distribution network, such as in an a vehicle, including a converter configured to receive first electrical energy from a power generator and convert the first electrical energy at a first voltage to second electrical energy at a second voltage, a plurality of battery cells configured to provide third electrical energy, a plurality of loads configured to receive at least a portion of the second electrical energy and a portion of the third electrical energy, and a power distribution device configured to electrically isolate a first subset of the plurality of loads from the converter and direct at least the second portion of the third electrical energy from the plurality of battery cells to the first subset of the plurality of loads, in response to an indication of a degradation associated with the power generator or one of the plurality of power distribution networks.

### CROSS REFERENCE TO RELATED APPLICATIONS

This application claims priority to, and the benefit of, Indian Provisional Patent Application No. 202421039036 filed on May 17, 2024 and entitled “A POWER NETWORK ARCHITECTURE FOR AUTONOMOUS VEHICLES,” the contents of which are hereby incorporated by reference in their entireties.

### BACKGROUND

Vehicles such as Class 8 trucks constitute a substantial amount of traffic on the highways mainly due to freight services provided by them. Each year, the demand for moving freight increases, resulting in more such vehicles on roads. Autonomous vehicles may be used to meet the increase in demand. For example, autonomous vehicles may be used to move freight faster (e.g., arriving at the destination sooner) and/or at lower costs. The use and operation of autonomous vehicles, however, may involve additional features relative to manually operated vehicles in order to ensure the proper operation of the autonomous vehicles. Therefore, improvements in the architecture of the autonomous vehicles may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter

In an aspect the present disclosure, an electrical system includes a power generator configured to provide first electrical energy, and a plurality of power distribution networks configured to receive the first electrical energy. Each of the plurality of power distribution networks includes: a converter configured to convert a portion of the first electrical energy at a first voltage to second electrical energy at a second voltage, a plurality of battery cells configured to provide third electrical energy, a plurality of loads configured to receive at least a portion of the second electrical energy and a portion of the third electrical energy, and a power distribution device. The power distribution device is configured to: identify an indication of a degradation associated with the power generator or one of the plurality of power distribution networks; electrically isolate, in response to the indication of the degradation, a first subset of the plurality of loads from the converter; and direct, in response to the indication of the degradation, at least the portion of the third electrical energy from the plurality of battery cells to the first subset of the plurality of loads.

Another aspect of the present disclosure includes an electrical system of an autonomous vehicle including a power generator configured to provide first electrical energy to a plurality of power distribution networks, the plurality of power distribution networks, each of the plurality of power distribution networks includes: a converter configured to convert a portion of the first electrical energy at a first voltage to second electrical energy at a second voltage, a plurality of battery cells configured to provide third electrical energy, a plurality of loads configured to receive at least a portion of the second electrical energy and a portion of the third electrical energy, and a power distribution device configured to control flows of electrical energy within the corresponding power distribution network, and a controller configured to: identify an indication of a degradation associated with the power generator or one of the plurality of power distribution networks, cause the power distribution device to electrically isolate, in response to the indication of the degradation, a first subset of the plurality of loads from the converter, and cause the power distribution device to direct, in response to the indication of the degradation, at least the portion of the third electrical energy from the plurality of battery cells to the first subset of the plurality of loads.

In an aspect of the present disclosure, power distribution network of a plurality of power distribution networks of a vehicle may include a converter configured to: receive first electrical energy from a power generator, and convert the first electrical energy at a first voltage to second electrical energy at a second voltage, a plurality of battery cells configured to provide third electrical energy, a plurality of loads configured to receive at least a portion of the second electrical energy and a portion of the third electrical energy, and a power distribution device configured to: identify an indication of a degradation associated with the power generator or one of the plurality of power distribution networks, electrically isolate, in response to the indication of the degradation, a first subset of the plurality of loads from the converter, and direct, in response to the indication of the degradation, at least the portion of the third electrical energy from the plurality of battery cells to the first subset of the plurality of loads.

Aspects of the present disclosure include a method for operating a power distribution device including receiving first electrical energy from a converter, receiving second electrical energy from a plurality of battery cells, providing at least one of the first electrical energy or the second electrical energy to a plurality of loads, identifying an indication of a degradation associated with a power generator of the autonomous vehicle or one of a plurality of neighbor power distribution networks, electrically isolating, in response to the indication of the degradation, a first subset of the plurality of loads from the converter, and directing, in response to the indication of the degradation, at least the second electrical energy from the plurality of battery cells to the first subset of the plurality of loads.

Additional aspects of the present disclosure will be described in more detail below.

### BRIEF DESCRIPTION OF THE FIGURES

In the description that follows, like parts are marked throughout the specification and drawings with the same numerals. The drawing figures are not necessarily drawn to scale and certain figures may be shown in exaggerated or generalized form in the interest of clarity and conciseness. The disclosure itself, as well as a preferred mode of use and further advantages thereof, will be best understood by reference to the following detailed description of illustrative aspects of the disclosure when read in conjunction with the accompanying drawings, wherein:

FIG. 1 is a block diagram of an electrical system of a vehicle according to aspects of the present disclosure.

FIG. 2 is a block diagram of a power distribution network according to aspects of the present disclosure.

FIG. 3 is a block diagram of an electrical system including indications relating to power management and distribution, and without the communication network, according to aspects of the present disclosure.

FIG. 4 is a block diagram of a power generator and an input voltage diagram including indications relating to power management and distribution, according to aspects of the present disclosure.

FIG. 5 is a flow chart of a method for operating a controller of an electrical system according to aspects of the present disclosure.

FIG. 6 is a block diagram of a backup braking system according to aspects of the present disclosure.

FIG. 7 is a block diagram of a backup steering system according to aspects of the present disclosure.

FIG. 8 is a block diagram of a controller according to aspects of the present disclosure.

FIG. 9 is a block diagram of the communication networks in the electrical system according to aspects of the present disclosure.

FIG. 10 is a block diagram of the power distribution device according to aspects of the present disclosure.

FIG. 11 is a flow chart of a method for operating a power distribution device to detect a degradation according to aspects of the present disclosure.

FIGS. 12A-B are a flow chart of a method for operating a power distribution device to control the state of the electrical system according to aspects of the present disclosure.

### DETAILED DESCRIPTION

The present disclosure relates to a vehicle having autonomous capabilities, including an “autonomous vehicle” and a “semi-autonomous vehicle.” Such vehicles may also be referred to as a self-driving vehicle, driverless vehicle, or robotic vehicle. While an autonomous vehicle may be driverless, a semi-autonomous vehicle includes a human driver to monitor the environment and be ready to take control when necessary. And, as used herein, autonomous capabilities for a vehicle refers to vehicular automation, that is, technology that can sense its environment and allow a vehicle to move safely with little or no human input. Autonomous and semi-autonomous vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage. The control systems further control the physical operation of the vehicle, e.g., via one or more actuators, based on the sensor information. In the following description, the terms autonomous vehicle and semi-autonomous vehicle may be used interchangeably and/or substituted for one another, unless stated otherwise, and generally refer to a vehicle having autonomous capabilities.

In one aspect of the present disclosure, for certain vehicles such as autonomous vehicles, there can be certain operational requirements. For example, certain electrical loads may be in a “always-on” state to ensure proper communication and/or security. Certain electrical loads associated with autonomous driving may draw significant power during flashing and/or updates. In certain times, the autonomous driving loads may be operated without running the engine. The batteries may require the storage of a threshold amount of electrical energy for certain applications, thus requiring a sufficient charging capability. The on-board power busses (i.e., power distribution networks) may require the ability to isolate for integrity/safety reasons.

Some aspects of the present disclosure include an electrical system for a vehicle, such as an autonomous or semi-autonomous vehicle. Examples of autonomous vehicles include vehicles that are classified by the Society of Automotive Engineers (SAE). For example, classes 3, 4, or 5 vehicles may be the autonomous vehicles described herein. Other standards or types of autonomous vehicles may also encompass one or more aspects of the present disclosure. The electrical system may be configured to be charged by various input power supplies that run on different supply voltages. Based on the supply voltage, operating conditions, battery statuses, and/or other factors, the electrical system may distribute the electrical energy to various components within the vehicle.

In some aspects, the electrical system may be compartmentalized into a number of sectors. The sectors may include various instruments for operating the vehicle. For instruments that are necessary for the proper and/or high integrity operation of the vehicle (e.g., brakes, steering, sensors, etc.), the electrical system may prioritize their energy consumption. As such, in the presence of an undesirable degradation of an electrical energy source (e.g., alternator degradation), the electrical system may direct a secondary electrical energy source (e.g., battery) to the instruments that can sufficiently contribute to desired high integrity operation of the vehicle, such as to bring the vehicle to a controlled stop. Further, to reduce unnecessary electrical energy consumption, the electrical system may suspend the energy consumption of other sectors (e.g., sectors with the instruments not necessary for the high integrity operation of the vehicle) to reduce electrical energy consumption.

In one aspect, the vehicle may include backup systems, loads, devices, and/or energy sources to prevent a one or more degradations in the vehicle. As such, in response to the degradation beyond some predetermined threshold of a first instrument (e.g., loss of pressure for the brake, loss of electrical power to steer the vehicle, etc.), a second, backup instrument is configured to operate the vehicle as desired.

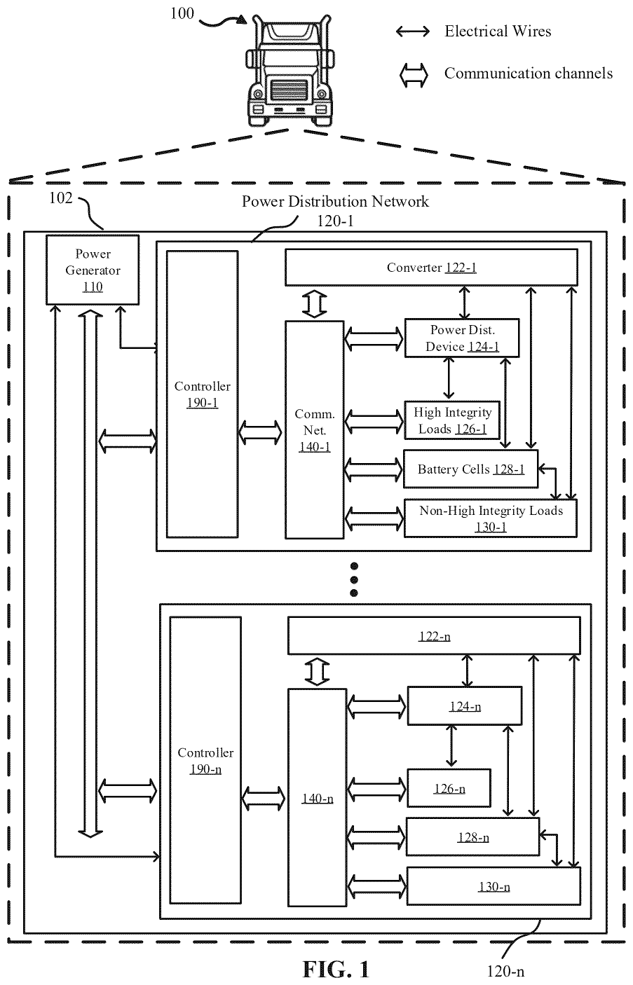

FIG. 1 is a block diagram showing an electrical system 102 of a vehicle 100 having a power distribution device or a controller configured to identify a degradation (e.g., a degradation beyond a predetermined threshold) within the electrical system 102 and/or the vehicle 100 and maintain a supply of power to components within the electrical system 102 directed to high integrity operation of the vehicle 102, e.g., high integrity components or loads, according to an aspect of the present disclosure. In some aspects, the electrical system 102 may include a power generator 110 configured to supply electrical energy to various components of the electrical system 102 as described below. The power generator 110 may include, but is not limited to, an alternator configured to generate an alternator current, and, optionally, a filter configured to filter the alternator current to generate an output current to provide a first electrical energy to the electrical system 102. The electrical system 102 may include two or more power distribution networks 120-1 . . . 120-n each having various circuitry and devices configured to operate various components of the vehicle 100. Here, the number n may be any positive integer greater than 1.

In some aspects, the first power distribution network 120-1 may include one or more first converters 122-1 configured to convert an input voltage to an output voltage. The one or more first converters 122-1 may include one or more power converter devices, such as but not limited to a DC-DC transformer, one or more rectifiers, and/or one or more passive/active electrical devices (e.g. resistor(s), capacitor(s), inductor(s), etc.). The first power distribution network 120-1 may include a first power distribution device 124-1 configured to manage electrical energy distribution within the first power distribution network 120-1. The first power distribution device 124-1 may include, but is not limited to, one or more switches. Examples of the one or more switches may include metal-oxide-semiconductor field effect transistors (MOSFETs), bipolar junction transistors (BJT), and/or other types of electronic switches configured to toggle between high impedance state and low impedance state. In some aspects, the switches may be driven by hardware and/or software.

In certain aspects of the present disclosure, the first power distribution network 120-1 may include a first plurality of high integrity loads 126-1 that include systems necessary for the vehicle 100 to operate safely during an occurrence of a degradation. In one aspect of the present disclosure, the term high integrity load as used herein refers to high integrity loads compliant with the ISO 26262 standards. In an implementation, the high integrity loads include an automotive safety integrity level D (ASIL-D) or ASIL-B (D) loads providing the required control for the proper maneuvering of the vehicle. In one example, the first plurality of high integrity loads 126-1 may include one or more of a brake system, a steering system, a visual sensor system, a virtual driver system, a fuel pump system, and/or other systems that contribute to the proper operation of the vehicle 100.

In an aspect of the present disclosure, the first power distribution network 120-1 may include a first plurality of battery cells 128-1 configured to store electrical energy. Further, the first plurality of battery cells 128-1 may be configured supply the stored electrical energy to various components inside or outside the electrical system 102 as described in further detail below.

In one aspect, the first power distribution network 120-1 may include a first plurality non-high integrity loads 130-1 that include systems that are not necessary for the vehicle 100 to operate safely during an occurrence of a degradation. In one aspect of the present disclosure, the term non-high integrity loads as used herein refers to quality managed (QM) loads in the vehicle. The QM loads may form the least critical workload according to the International Organization for Standardization (ISO) 26262 functional safety standard. QM loads are non-high integrity loads such that the degradation of such loads does not have an adverse effect on the vehicle operation. The QM loads may include, but are not limited to, loads such as audio system, internal lighting, cooling or heating, etc. In an example, the first plurality non-high integrity loads 130-1 may include one or more of a lighting system, an entertainment system, a navigation system, a heating, ventilation, and air conditioning system, and/or other systems or loads that do not interfere with the proper operation of the electrical system 102 and/or vehicle 100.

In some aspects of the present disclosure, the first power distribution network 120-1 may include a first communication network 140-1 configured to provide a communication medium for the components of the first power distribution network 120-1 to communicate with one another. In one instance, the first communication network 140-1 may include a controller area network (CAN) within the first power distribution network 120-1. In another aspect, the first communication network 140-1 may include a local area network (LAN) within the first power distribution network 120-1. Other types of communication networks and/or other communication protocols may also be implemented according to various aspects of the present disclosure.

As used herein, the term “communication network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

In certain aspects of the present disclosure, the electrical system 102 may include the two or more power distribution networks 120-1 . . . 120-n to provide redundancy in the operation of the vehicle 100. As such, in response to a partial or complete degradation of one power distribution network of the two or more power distribution networks 120-1 . . . 120-n, another power distribution network may begin or continue operating the vehicle 100 at full or partial capacity. Each of the two or more power distribution networks 120-1 . . . 120-n may include the same or different components as described above. For example, the n^{th} power distribution network 120-n may include one or more n^{th} converters 122-n, an n^{th} power distribution device 124-n, an n^{th} plurality of high integrity loads 126-n, an n^{th} plurality of battery cells 128-n, an n^{th} plurality of non-high integrity loads 130-n, and/or an n^{th} communication network 140-n as described above.

In one aspect, the first plurality of high integrity loads 126-1 may include identical systems as the n^{th} plurality of high integrity loads 126-n. For example, both the first plurality of high integrity loads 126-1 and the n^{th} plurality of high integrity loads 126-n may include braking systems and steering systems. In another aspect, each plurality of high integrity loads may include different systems necessary for the proper operation of the vehicle 100, such as braking and/or steering systems.

In certain aspects, if the electrical system 102 includes more than two power distribution networks, each plurality of high integrity loads may include the same or different loads or systems as one or more other plurality of high integrity loads.

In some aspects of the present disclosure, the communication networks 140-1 . . . 140-n may be separate networks, or integrated as a single communication network. For example, the communication networks 140-1 . . . 140-n may be part of a single CAN or LAN within the electrical system 102.

In an aspect of the present disclosure, the electrical system 102 may include a plurality of controllers 190-1 . . . 190-n each configured to control various operations of the components within the electrical system 102. The plurality of controllers 190-1 . . . 190-n may each be configured to transmit signals to, and/or receive signals from, various components via communication channels (e.g., electrical and/or optical wires, or wireless communication channels) of the electrical system 102 and/or one or more of the communication networks 140-1 . . . 140-n. In an example, each of the plurality of controllers 190-1 . . . 190-n may be implemented as a single device that executes stored instructions to implement various functions of various electronic control units (ECUs). In another example, each of the plurality of controllers 190-1 . . . 190-n may be implemented as a number of standalone ECUs each embedded with a corresponding component of the electrical system 102 (e.g., a converter ECU for the converter, a power distribution ECU for the power distribution device, etc.). In one implementation, each of the plurality of controllers 190-1 . . . 190-n may be integrated into the respective power distribution device 124. As such, each of the plurality of controllers 190-1 . . . 190-n may function as the “master” controller for operating the respective power distribution network 120. Other configurations may also be implemented according to various aspects of the present disclosure.

The term “electronic control unit” (ECU), also known as an “electronic control module,” is a system and/or processor(s) that controls one or more subsystems. An ECU may be installed in a truck or other motor vehicle. It may refer to many ECUs, and can include, but is not limited to, control units such as an Engine Control Module (ECM), a Powertrain Control Module (PCM), a Transmission Control Module (TCM), a Brake Control Module (BCM) or Electronic Brake Control Module (EBCM), a Central Control Module (CCM), a Central Timing Module (CTM), a General Electronic Module (GEM), a Body Control Module (BCM), and a Suspension Control Module (SCM). ECUs together are sometimes referred to collectively as the vehicle computer or the vehicle central computer, and may include separate computers. In an example, the electronic control unit can be an embedded system in automotive electronics. In another example, the electronic control unit is wirelessly coupled with the automotive electronics.

Aspects of the present disclosure may include the electrical system 102 being configured to rely on one or more backup systems to continue the proper operation of the vehicle 100 during a degradation of a component of the electrical system 102. Examples of a degradation within the electrical system 102 and/or the vehicle 100 may include a degradation in the power generator 110 (e.g., alternator degradation, short circuit, open circuit, etc.), an open electrical wire, a failed converter, a short in the electrical wires, or other degradations that may interfere with proper operation of the electrical system 102 and/or vehicle 100.

In operation, at least one of the power distribution devices 124-1 to 124-n, and/or one of the plurality of controllers 190-1 . . . 190-n, is configured to identify a degradation within the electrical system 102 and/or the vehicle 100. In response, in order to maintain a proper operation of the vehicle 100 in view of the degradation, the respective power distribution device 124-1 to 124-n, and/or one of the plurality of controllers 190-1 . . . 190-n, is configured to maintain a supply of power to at least one of the plurality of high integrity loads 126-1 to 126-n, such as by directing and/or re-directing (e.g., via one or more switches) power from the generator 110 and/or at least one of the plurality of battery cells 128-1 to 128-n to the at least one of the plurality of high integrity loads 126-1 to 126-n, as described in more detail below. Additionally, in some cases, in view of the degradation and to conserve the available power for the at least one of the plurality of high integrity loads 126-1 to 126-n, the respective power distribution device 124-1 to 124-n, and/or one of the plurality of controllers 190-1 . . . 190-n, is configured to reduce and/or disconnect a supply of power to at least one or all of the plurality of non-high integrity loads 130-1 to 130-n.

In certain aspects of the present disclosure, the controller 190 may be configured to detect a degradation within the electrical system 102 as described below. A degradation may be an event that occurs within the electrical system 102 that negatively impacts the operation of the electrical system 102.

In some aspects of the present disclosure, at least some of the two or more power distribution networks 120-1 . . . 120-n may be disposed at different physical locations within the vehicle 100. As such, any positional dependent degradation to a particular location of the vehicle 100 is less likely to incapacitate all of the two or more power distribution networks 120-1 . . . 120-n. In other words, a positional dependent degradation to a particular location of the vehicle 100 may be less likely to stop the supply of electrical energy to at least one of the plurality of high integrity loads 126, which will allow the electrical system 102 to continue operating the vehicle 100 (e.g., steering and/or braking the vehicle 100).

Other configurations may also be implemented according to aspects of the present disclosure. Detailed descriptions of the plurality of controllers 190-1 . . . 190-n are described below.

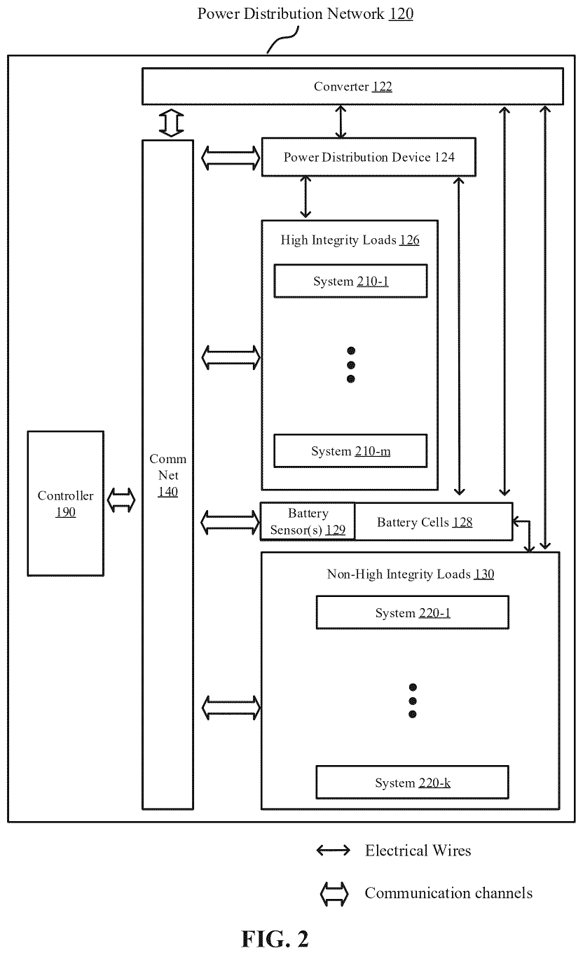

FIG. 2 is a block diagram of the power distribution network 120 showing components of the power distribution network 120 according to various aspects of the present disclosure. The power distribution network 120 shown here may be any one of the power distribution networks 120-1 . . . 120-n (FIG. 1). Here, the plurality of high integrity loads 126 may include m systems 210-1 . . . 210-m that are used by the vehicle 100 (FIG. 1) to operate safely during an occurrence of a degradation in the electrical system 102. Here, m may be a positive integer greater than 2. Examples of the m systems 210-1 . . . 210-m include a brake system, a steering system, a visual sensor system, a virtual driver system, a fuel pump system, and/or other systems.

In one aspect, the plurality of non-high integrity load 130 may include k systems 220-1 . . . 220-k that are not necessary for the vehicle 100 to operate safely during an occurrence of a degradation. Here, k may be a positive integer. In some aspects of the current disclosure, the terms k, m, and n (FIG. 1) may be the same or different. Examples of the k systems 220-1 . . . 220-k may include one or more of a lighting system, an entertainment system, a navigation system, a heating, ventilation, and air conditioning system, and/or other systems.

In certain aspects, the battery cells 128 may include one or more batteries and/or battery cells. The battery cells 128 may include one or more battery sensors 129 configured to monitor various parameters associated with the battery cells, for example, the health, temperature, and/or charge capacity of the battery cells 128. Here, the health of the battery cells may relate to one or more of a retention capability of the battery cells, loss related to the battery cells, or other factors that impact the performance of the battery cells. The one or more battery sensors 129 may transmit battery information (e.g., health, charge capacity, temperature, etc.) to the controller 190 via the communication channels of the electrical system 102 and/or the communication network 140. The one or more battery sensors 129 may transmit the battery information in series or in parallel across the communication channels.

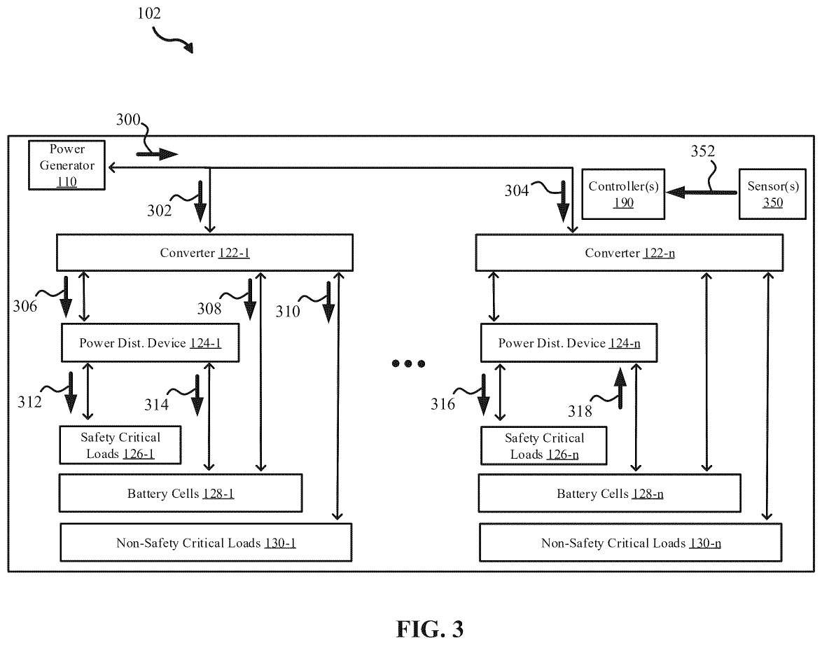

FIG. 3 is a block diagram of the electrical system 102 including indications (the bolded arrows) relating to power management and distribution, according to certain aspects of the present disclosure. In this diagram, the communication channels and the communication networks (FIG. 1) are omitted for clarity. Details relating to the indications are described below.

In some aspects, referring to FIG. 3, each of the two or more power distribution networks 120-1 . . . 120-n may receive, in parallel, at least a portion of one or more supplied currents 300 from power generator 110 via the electrical wires. In an instance, the one or more first converters 122-1 of the first power distribution network 120-1 may receive a first portion 302 of the one or more supplied currents 300 from the power generator 110. The one or more first converters 122-1 may reduce the voltages of the received first portion 302 of the one or more supplied currents 300 to a voltage sufficiently low to be used by components of the first power distribution networks 120-1. As such, the one or more first converters 122-1 may convert the first portion 302 of the one or more supplied currents 300 to currents 306, 308, 310. For example, the one or more first converters 122-1 may step the voltage of the first portion 302 of the one or more supplied currents 300, namely 48 Volts (V), down to the voltage of the currents 306, 308, 310, namely 12 V. In certain aspects, the one or more first converters 122-1 may step down the voltage of the first portion 302 of the one or more supplied currents 300 from a range of 30-60 V, 35-55 V, or 40-50V down to a range of 0-25 V, 2-20 V, or 5-18 V. Other input and/or output voltages may also be possible according to various aspects of the present disclosure.

In certain aspects, the one or more first converters 122-1 may provide the current 306 to the first power distribution device 124-1, the current 308 to the first battery cell 128-1, and the current 310 to the first plurality non-high integrity loads 130-1.

In some aspects of the present disclosure, the first power distribution device 124-1 may provide currents 312, 314 to the first plurality of high integrity loads 126-1 and/or the first battery cell 128-1, respectively.

Similarly, the one or more n^{th} converters 122-1 of the n^{th} power distribution network 120-n may receive a second portion 304 of the one or more supplied currents 300 from the power generator 110, and distribute the received portion as described above and/or according to various aspects of the present disclosure described elsewhere herein.

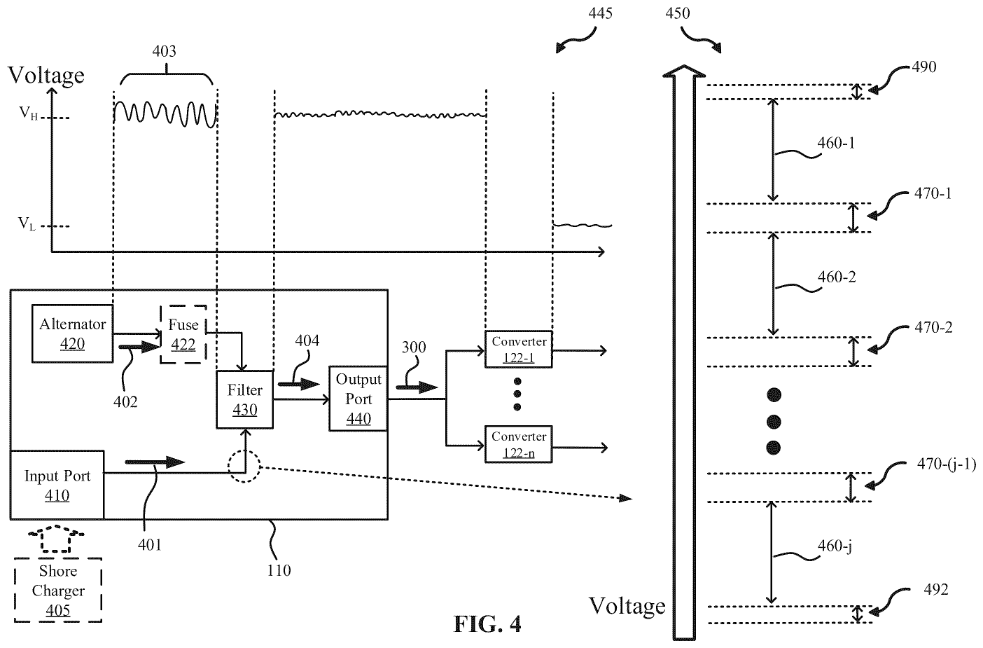

FIG. 4 is block diagram of the power generator 110, an alternator voltage diagram 445, and an input voltage diagram 450 including indications (the bolded arrows) relating to power management and distribution, according to some aspects of the present disclosure. The generator 110 may provide electrical energy to the vehicle 100 (FIG. 1) via internally generated electrical current or externally provided electrical energy. In a first aspect, the power generator 110 may provide electrical energy by relying on an engine (not shown) to drive an alternator 420. In a second aspect, the power generator 110 may receive electrical current via one or more shore chargers 405, and provide the received electrical energy to the vehicle 100 as described below.

In an aspect of the present disclosure, the power generator 110 may include the alternator 420. The alternator 420 may be driven by a belt (e.g., a serpentine belt) using mechanical/rotational forces from of an engine (e.g., such as a diesel engine, not shown) of the vehicle 100. The rotation of the alternative 420 may generate an AC current, which may be rectified into a DC current to be supplied to the vehicle 100. For example, the alternator 420 may include one or more rectifiers (e.g., diodes) configured to rectify the AC current generated based on the rotation of the alternator 420 into a DC current. The alternator 420 may be configured to output the rectified DC current as an alternator current 402. The power generator 110 may include an optional fuse 422 configured to control the maximum current level of the alternator current 402.

In one aspect, the power generator 110 may include a filter 430 configured to filter the input current 401 and/or the alternator current 402 into an output current 404. The filter 430 may include one or more bandpass filters, high pass filters, capacitors, inductors, resistors, or other active or passive electrical components. In one aspect, the filter 430 may include one or more capacitors having capacitance in the range of 1 microfarad (μF) to 100 millifarad (mF), or 10 μF to 10 mF, or 100 μF to 1 mF, or other suitable range depending on the electrical system 102. In some aspects, the filter 430 may be configured to filter out noises, ripples, and/or fluctuations in the input current 401 and/or the alternator current 402 to generate the output current 404. In other aspects, the filter 430 may be configured to increase the stability of the output current 404 during sudden increase and/or decrease of the electrical loads. In some aspects, the power generator 110 may include an output port 440 configured to output the output current 404 as the one or more supplied currents 300. The output port 440 may be a switch that directs portions of the output current 404 to various components of the electrical system 102, such as the to the converters 122-1 . . . 122-n of the two or more power distribution networks 120-1 . . . 120-n (FIG. 1).

In another aspect, the controllers 190-1 . . . 190-n may adjust the slew rate of the converters 122-1 . . . 122-n to increase the stability of the input/output voltages. For example, the controllers 190-1 . . . 190-n may decrease the slew rate to reduce the fluctuations. Other methods of adjustments may also be used according to aspects of the present disclosure.

In some aspects of the present disclosure, the alternator voltage diagram 445 may illustrate an example of the voltage profile from the alternator 420 to after the converters 122-1 . . . 122-n. As indicated above, the alternator 420 may generate the alternator current 402. The alternator current 402 may have a high voltage V_{H}. For example, the high voltage V_{H} may be 35 V, 40 V, 45 V, 48 V, 50 V, 55 V, 60 V, or other voltages. The alternator current 402 may include ripples 403 due to the effect of DC load dump. Specifically, since the alternator current 402 is not directly provided to any battery, there are no batteries to damp the ripples 403 generated by the alternator 420. The ripples 403 may be undesirable as the voltage at the “peaks” of the ripples may be too high for the electrical system 102 (FIG. 1). The filter 430 may reduce and/or remove the ripples 403. As shown in the diagram, the filter 430 may reduce and/or remove the ripples 403 to produce the output current 404. The output current 404 may have substantially the same voltage, and/or in the same voltage range, as the alternator current 402. Specifically, the output current 404 may have the high voltage V_{H}. Subsequently, the output port 440 may provide the output current 404 as the one or more supplied currents 300 (with the ripples 403 reduced or removed) to the to the converters 122-1 . . . 122-n. Other types of fluctuations may also be filtered out by the filter 430. Examples of fluctuations may include unstable oscillations in output voltage.

In some aspects, each of the converters 122-1 . . . 122-n may step down the one or more supplied currents 300 at the high voltage Vcurrents 306, 308, 310 (FIG. 3)) at a low voltage V_{L}. For example, the low voltage V_{L} may be 12 V, 13 V, 14 V, 14.2 V, 15 V, 16 V, or other voltages.

In certain aspects of the present disclosure, one of the plurality of controllers 190-1 . . . 190-n (such as the first controller 190-1) may transmit one or more signals to the alternator 420 to set the alternator voltage of the alternator current 402 (i.e., the high voltage V_{H}). One of the plurality of controllers 190-1 . . . 190-n may transmit one or more signals to the converters 122-1 . . . 122-n to set the voltage(s) of the currents 306, 308, 310 (i.e., the low voltage V_{L}). In some instances, each of the converters 122-1 . . . 122-n may set the same or different voltages for the currents 306, 308, 310.

In an aspect of the present disclosure, the alternator 420 may adjust the alternator current 402 based on the load in the power distribution networks 120-1 . . . 120-n. For example, if the battery cells 128-1 . . . 128-n are fully charged, the demand for electrical current in the electrical system 102 may decrease. Since less electrical current is being sunk into the power distribution networks 120-1 . . . 120-n (due to the battery cells 128-1 . . . 128-n no longer behaving like a load), the alternative voltage of the alternative current 402 may rise, possibly above the set point by the one of the plurality of controllers 190-1 . . . 190-n indicated above. In response, the alternator 420 may reduce the alternator current 402 to react to the decrease in load.

In an aspect, and referring to FIGS. 1-4, the power generator 110 may include an input port 410 configured receive an input current 401 from an external source. For example, the input port 410 may be plugged into a single charger or multiple chargers. The one or more shore chargers 405 may be plugged into power generator 110 to supply electricity to the vehicle 100. The output voltages of the one or more shore chargers 405 may be between 0 V to 60 V, 10 V to 50 V, or 12 V to 48 V. In one aspect, the output voltages of the one or more shore chargers 405 may be 12 V, 24 V, 36 V, or 48 V. Other voltages and/or voltage ranges may also be used.

Here, a shore charger is a device or system used to supply electrical power from a land-based source (e.g., the “shore”) to a vehicle. As such, the power generator 110 may provide electrical energy to one or more components, depending on the voltage supplied by the stationary charging port, the conditions of the electrical system 102, and/or other variables. Examples of various charging operations are described below.

In some aspects, during the shore charging operations, one of the plurality of controllers 190-1 . . . 190-n may transmit signals to devices within the electrical system 102 to distribute the input current 401 to one or more components of the electrical system 102 based on the voltage of the input voltage of the input current 401 and/or the output voltage of the one or more shore chargers 405. As an example, one of the plurality of controllers 190-1 . . . 190-n may transmit signals to the converters 122-1 . . . 122-n to set the current limit of the converters 122 . . . 122-n that will be distributed to one or more components of the electrical system 102 based on the input voltage of the input current 401 (e.g., provided by the one or more shore chargers 405). Distribution is less so the control mechanism, but the amount of current that will be pulled from the charger. In one instance, one of the plurality of controllers 190-1 . . . 190-n may cause the input current 401 to be distributed to all the components in the electrical system 102. In another aspect, one of the plurality of controllers 190-1 . . . 190-n may cause the input current 401 to be distributed to all the components in a single power distribution network of the two or more power distribution networks 120-1 . . . 120-n. In other aspects, one of the plurality of controllers 190-1 . . . 190-n may cause the input current 401 to be distributed to similar components in each of the two or more power distribution networks 120-1 . . . 120-n. In yet another aspect, one of the plurality of controllers 190-1 . . . 190-n may cause the input current 401 to be distributed to a single component in a single power distribution network 120. Other power distribution schemes may also be used according to aspects of the present disclosure.

For instance, during a first shore charging operation associated with the one or more shore charger 405, the input voltage of the input current 401 being in the first voltage band 460-1, the input port 410 may receive the input current 401 from the one or more shore charger 405. The input current 401 may be filtered, by the filter 430, into the output current 404. One of the plurality of controllers 190-1 . . . 190-n (such as the first controller 190-1) may determine that the input voltage of the input current 401 is in the first voltage band 460-1. As such, the power generator 110 may provide the output current 404 as one or more supplied currents 300 to the electrical system 102. Here, the input voltage may be 48 V. Other voltage levels may also be possible. The input voltage may be sufficiently high such that the first controller 190-1 may distribute the input electrical energy to multiple components within the electrical system 102 as described below, including the first battery cell 128-1.

In some aspects, each of the two or more power distribution networks 120-1 . . . 120-n may receive, in parallel, at least a portion of one or more supplied currents 300 from power generator 110 via the electrical wires. In an instance, the one or more first converters 122-1 of the first power distribution network 120-1 may receive the first portion 302 of the one or more supplied currents 300 from the power generator 110. The one or more first converters 122-1 may reduce the voltages of the receive first portion 302 of the one or more supplied currents 300 to a voltage sufficiently low to be used by components of the first power distribution networks 120-1. As such, the one or more first converters 122-1 may convert the first portion 302 of the one or more supplied currents 300 to currents 306, 308, 310.

In certain aspects, the one or more first converters 122-1 may provide the current 306 to the first power distribution device 124-1. The one or more first converters 122-1 may provide the current 308 to the first battery cell 128-1. The one or more first converters 122-1 may provide the current 310 to the first plurality non-high integrity loads 130-1. The first power distribution device 124-1 may provide currents 312, 314 to the first plurality of high integrity loads 126-1 (if applicable) and/or the first battery cell 128-1, respectively.

Similarly, the one or more n^{th} converters 122-1 of the n^{th} power distribution network 120-n may receive the second portion 304 of the one or more supplied currents 300 from the power generator 110, and distribute the received portion according to various aspects of the present disclosure.

In another example, during a second shore charging operation associated with the shore charger 405, the input voltage of the input current 401 being in the second voltage band 460-2, the input port 410 may receive the input current 401 from an external charger. The input current 401 may be filtered, by the filter 430, into the output current 404. The first controller 190-1 may determine that the input voltage of the input current 401 is in the second voltage band 460-2. As such, the power generator 110 may provide the output current 404 as one or more supplied currents 300 to the electrical system 102. Here, the input voltage may be 36 V. Other voltage levels may also be possible. During the second charging operation, the input voltage may be sufficiently high to distribute the input electrical energy to multiple components, but not all components, within the electrical system 102. As such, the first controller 190-1 may transit signals to the one or more first converters 122-1 to direct the first portion 302 of the one or more supplied currents 300 to the high integrity loads 130-1 and the first battery cell 128-1.

In some aspects, each of the two or more power distribution networks 120-1 . . . 120-n may receive, in parallel, at least a portion of one or more supplied currents 300 from power generator 110 via the electrical wires. In an instance, the one or more first converters 122-1 of the first power distribution network 120-1 may receive the first portion 302 of the one or more supplied currents 300 from the power generator 110. The one or more first converters 122-1 may reduce the voltages of the receive first portion 302 of the one or more supplied currents 300 to a voltage sufficiently low to be used by components of the first power distribution networks 120-1. However, since the input voltage of the input current 401 is in the second voltage band 460-2, the one or more first converters 122-1 may convert the first portion 302 of the one or more supplied currents 300 to currents 306, 308.

In certain aspects, the one or more first converters 122-1 may provide the current 306 to the high integrity loads 130-1 and the current 308 to the first battery cell 128-1 without supplying the first plurality non-safety critical loads 130-1. The first controller 190-1 may decide the above current distribution because the input voltage is in the second voltage band 460-2.

In yet another example, during a third shore charging operation associated with the shore charger 405, the input voltage of the input current 401 being in the j^{th} voltage band 460-j, the input port 410 may receive the input current 401 from an external charger. The input current 401 may be filtered, by the filter 430, into the output current 404. The first controller 190-1 may determine that the input voltage of the input current 401 is in the j^{th} voltage band 460-j. As such, the first controller 190-1 may send signals to the power generator 110 to provide the output current 404 as one or more supplied currents 300 to the electrical system 102. During the third charging operation, the input voltage may be insufficient to supply multiple components in the electrical system 102. Therefore, the first controller 190-1 may only distribute the electrical energy to certain components within the electrical system 102 as described below. In other aspects of the present disclosure, the first controller 190-1 may lower the current setpoint(s) for the converters 122-1 . . . 122-n. As such, the components in the electrical system 102 may be charged at a lower rate in response to the input voltage of the input current 401 being in the j^{th} voltage band 460-j compared to the input voltage of the input current 401 being in the “higher” bands (e.g., 460-1, 460-2 . . . ) as described above.

In some aspects, such as during operation of the vehicle 100, the first power distribution network 120-1 may receive the first portion 302 of the one or more supplied currents 300 from power generator 110 via the electrical wires. The one or more first converters 122-1 may reduce the voltages of the receive first portion 302 of the one or more supplied currents 300 to a voltage sufficiently low to be used by components of the first power distribution networks 120-1. As such, the one or more first converters 122-1 may convert the first portion 302 of the one or more supplied currents 300 to currents 306, 308, 310. Because the input voltage is “low,” the first controller 190-1 may cause the converter 122-n to not receive the second portion 304 of the one or more supplied currents 300.

During the shore charging operations, if the input voltage of the input current 401 is within one of the identification gaps 470-1, 470-2 . . . 470-(j−1), the first controller 190-1 may determine there is an error associated with the input current 401 because the first controller-1 190 may be unable to determine which voltage band the input voltage belongs to.

Similarly, during the shore charging operations, if the input voltage of the input current 401 is in or higher than the first safety range 490, each of the converters 122 exposed to the input voltage (via the output voltage of the output current 404) may respond by opening an internal protection device (not shown), such as a MOSFET, a breaker, or other suitable devices, to protect the plurality of power distribution networks 120-1 . . . 120n from potential electrical damage due to over voltage. The triggering of the internal protection MOSFET may cause one or more signals to be sent to the first controller 190-1. As such, the first controller 190-1 may receive the one or more signals indicating the over voltage, and take appropriate actions such as notifying the driver, opening additional switches to suspend the input current 401, and/or other actions.

During the shore charging operations, if the input voltage of the input current 401 is in or lower than the second safety range 490, one or more voltage sensors (e.g., the one or more sensors 350) in the power generator 110 and/or one or more of the converters 122 may detect the under voltage. The one or more voltage sensors may transmit one or more signals (e.g., via the sensor feedback information 352) to the first controller 190-1 indicating the under voltage. In response, the first controller 190-1 may take appropriate actions such as notifying the driver, opening switches to prevent loss of stored electrical charges, and/or other actions.

Aspects of the present disclosure may include the plurality of controllers 190-1 responding to one or more degradation events that occur in the electrical system 102 by properly supplying electrical energy to certain components to ensure the proper operation of the vehicle 100.

In a first example, a degradation may occur during a vehicle operation where the alternator 420 may be unable to output any current. Since the vehicle 100 is not being charged, the power generator 110 may be unable to supply any electrical energy to the power distribution networks 122-1 . . . 122-n. As such, one of the plurality of controllers 190-1 . . . 190-n (e.g., the first controller 190-1) may prioritize the operation of the pluralities of high integrity loads 126. Therefore, the first controller 190-1 may direct the electrical energy stored in the battery cells 128 toward the corresponding plurality of high integrity loads 126. The degradation may be detected by one or more sensors in the alternator 420 and/or the power generator 110, as is described below in more detail.

In some aspects, the first controller 190-1 may isolate the power distribution networks 120 from the power generator 110 and/or each other. For example, the controller 190 may open (and/or send signals to instruct) one or more switches to isolate the power distribution networks 120. Additionally or alternatively, the controller 190 may disconnect the electrical connectivity between the battery cells 128 of each power distribution network 120 from the corresponding plurality of non-high integrity loads 130. For example, the first controller-1 190 may open (and/or send signals to instruct) one or more switches to isolate the corresponding plurality of non-high integrity loads 130. As such, the first controller 190 may direct the electrical energy stored in the battery cells 128 toward the corresponding plurality of high integrity loads 126.

In one example, the first controller 190-1 may transmit one or more signals over the communication networks and/or communication channels to the power distribution device 124-n of the n^{th} power distribution network 120 to cause the stored current 318 in the n^{th} battery cell 128-n to flow toward the n^{th} power distribution network 120. Next, the first controller 190-1 may transmit one or more signals to the n^{th} power distribution device 124-n may re-direct the stored current 318 as the internally supplied current 316 toward the n^{th} plurality of high integrity loads 126-n. As such, the n^{th} plurality of high integrity loads 126-n may ensure the proper operation of the vehicle 100.

In an aspect, the controller 190 may isolate the defective component and/or the backup component in the electrical system 102 In the example above, the controller 190 may utilize the n^{th} power distribution device 124-n to isolate the n^{th} plurality of high integrity loads 126-n and the n^{th} battery cell 128-n from the remaining portion of the electrical system 102. For example, the controller 190 may identify the defective component, and transmit one or more signals to switches “surrounding” the defective component to toggle to the open position to electrically isolate the defective component. As such, any degradation in the rest of the electrical system 102 may not impact the operation of the backup system.

In a second example, a degradation may occur during of a vehicle operation where the first power distribution network 120-1 and its subcomponents may fail. As such, the first plurality of high integrity loads 126-1 may be unable to provide high integrity functions to the vehicle 100 (e.g., braking, steering, pumping fuels, etc.). Further, the first controller 190-1 may be unable to perform any programmed functions. As such, the n^{th} controller 190-n may transmit one or more signals to the remaining power distribution networks (e.g., the n^{th} power distribution network 120-n) to “take over” the high integrity functions. The remaining power distribution networks may provide operational redundancies to the first power distribution network 120-1.

In one aspect, each the plurality of controllers 190-1 . . . 190-n may be implemented as multiple distributed ECUs across the corresponding power distribution network 120 of the electrical system 102. The distributed ECUs of the plurality of controllers 190-1 . . . 190-n may be integrated with one or more of the power generator 110, the converters 122-1 . . . 122-n, the power distribution devices 124-1 . . . 124-n, the battery cells 128-1 . . . 128-n, the pluralities of high integrity loads 126-1 . . . 126-n, and/or the pluralities of non-high integrity loads 130-1 . . . 130-n. Further, the distributed ECUs may be integrated in subcomponents of the components described above. Other configurations for the plurality of controllers 190-1 may also be implemented according to various aspects of the present disclosure.

By implementing the distributed configuration for each of the plurality of controllers 190-1 . . . 190-n, the probability for a “complete” degradation of the plurality of controllers 190-1 . . . 190-n is reduced. Specifically, the probability for the plurality of controller 190-1 . . . 190-n be part of the degradation and/or be unable to trigger backup high integrity functions is diminished. Specifically, if one of the plurality of controllers 190-1 . . . 190-n is not operational, another one of the plurality of controllers 190-1 . . . 190-n may take over.

In one aspect of the present disclosure, each of the power distribution devices 124-1 . . . 124-n may include a power distribution ECU. Each power distribution ECU may be configured to operate on the electrical energy from a corresponding battery cell of the battery cells 128-1 . . . 128-n. Each power distribution ECU may be configured to manage the power distribution and/or usage of the corresponding power distribution network. Each power distribution ECU may be interconnected with the remaining power distribution ECUs via backup communication channels and/or backup communication networks. These backup communication channels and/or networks may be different than the communication channels and networks described above with respect to FIGS. 1 and 2. As such, if a network fails, the power distribution ECUs may rely on the “back-up” network to maintain communications among the power distribution ECUs. In one example, each of the plurality of controllers 190-1 . . . 190-n may include multiple ECUs, and a power distribution ECU associated with the first power distribution device 124-1 may transmit a status signal indicating a degradation of the first power distribution device 124-1, or fail to transmit a scheduled status signal indicating no degradation at the first power distribution device 124-1, to the n^{th} power distribution device 124-n. As a result, the n^{th} power distribution device 124-n may detect a degradation in the first power distribution device 124-1, and take one or more corrective actions as describe above.

In certain aspects, each of the plurality of controllers 190-1 . . . 190-n may detect one or more degradations by receiving, or failing to receive, sensor feedback information 352 from one or more sensors 350. The one or more sensors 350 may include electrical, mechanical, gyroscopic, optical, acoustic, and/or other types of sensors configured to detect degradations and/or abnormalities associated with various components of the vehicle 100. In other aspects, each of the plurality of controllers 190-1 . . . 190-n may detect one or more degradations by receiving and/or failing to receive one or more status signal from one or more ECUs.

In an aspect, sensors 350 may be removably or fixedly installed within the vehicle and may be disposed in various arrangements to provide information to the autonomous operation features. The sensors 350 may include, but are not limited to, one or more of a GPS unit, a radar unit, a LIDAR unit, an ultrasonic sensor, an infrared sensor, an inductance sensor, a camera, an accelerometer, a tachometer, or a speedometer. Some of the sensors 350 (e.g., radar, LIDAR, or camera units) may actively or passively scan the vehicle environment for obstacles (e.g., other vehicles, buildings, pedestrians, etc.), roadways, lane markings, signs, or signals. Other sensors 350 (e.g., GPS, accelerometer, or tachometer units) may provide data for determining the location or movement of the vehicle (e.g., via GPS coordinates, dead reckoning, wireless signal triangulation, etc.).

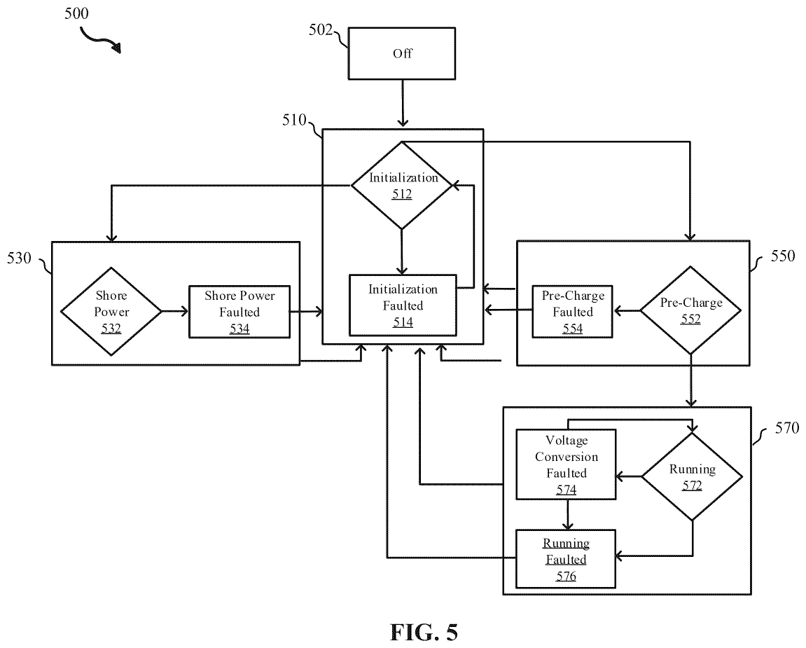

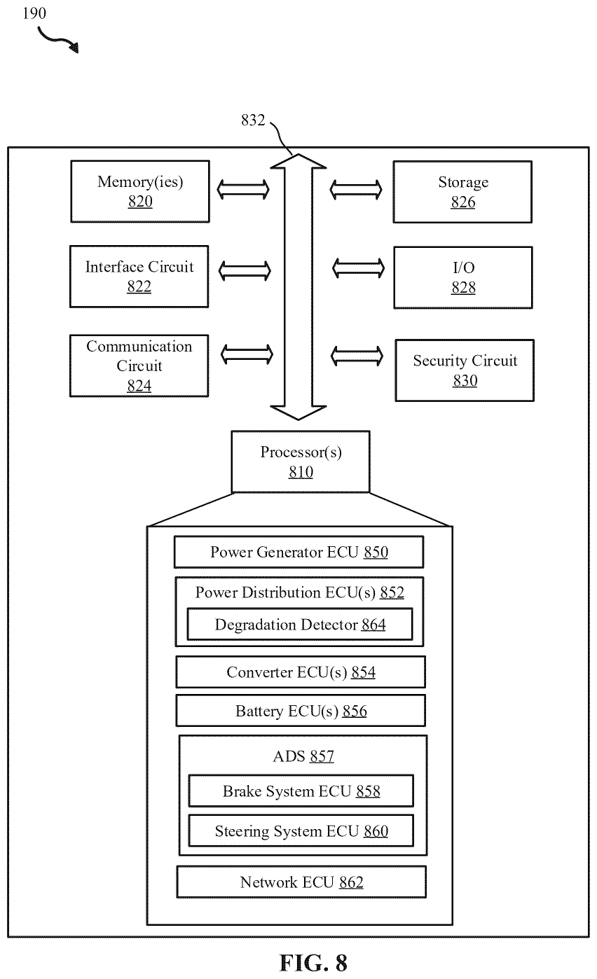

FIG. 5 is a flow chart for a method 500 of operating the first controller 190-1 of the electrical system 102 according to some aspects of the present disclosure. In some aspects, and referring to FIGS. 1-5, the method 500 may begin with the first controller 190-1 in an off state 502. The driver of the vehicle 100 may transition the first controller 190-1 from the off state 502 to an initialization state 510. For example, the driver of the vehicle 100 may insert the vehicle key into the ignition and/or move the vehicle key to a first position to transition from the off state 502 to the initialization state 510. Other methods of indicating the states may also be used according to various aspects of the present disclosure. For example, the virtual driver of the ADS 857 (FIG. 8) may transition the vehicle 100 into the initialization state 510. In another example, the driver of the vehicle 100 may indicate the transition to the initialization state 510 by pressing an ignition button or transmitting a signal from a mobile device (not shown) to activate remote start.

At the initialization state 510, the first controller 190-1 may begin the initialization process 512. The initialization process 512 may include one or more of the following processes: booting one of the plurality of controllers 190-1 . . . 190-n, executing a bootloader, and/or other processes. If the initialization process 512 is successful, the first controller 190-1 may be ready to enter a shore power state 530 or a pre-charge state 550. For example, the driver of the vehicle 100 may move the vehicle key in the ignition from the first position (associated with the initialization state 510) to a second position (associated with the shore power state 530) or to a third position (associated with the pre-charge state 550). If the initialization process 512 is unsuccessful, the first controller 190-1 may enter the initialization faulted step 514. In response, the first controller 190-1 may attempt the initialization process 512 again.

In one aspect of the present disclosure, the driver of the vehicle 100 may transition the first controller 190-1 from the initialization state 510 to the shore power state 530 (after successful initialization in the initialization state 510). The first controller 190-1 may begin operating in the shore power state 530.

If the shore power process 532 is successful, the first controller 190-1 may continue to operate in the shore power state 530 (e.g., charging the battery cells 128, providing electrical energy to the non-high integrity loads 130, etc.). If the shore power process 532 is unsuccessful (e.g., shore charger not connected, overvoltage, undervoltage, etc.), the first controller 190-1 may enter into a shore power faulted state 534 and/or return back to the initialization state 510. For example, the first controller 190-1 may detect the input voltage of the input current 401 supplied by the one or more shore chargers 405. Based on the volage levels of the input voltage as described above, the first controller 190-1 may take one or more actions as described above.

In another aspect of the present disclosure, the driver of the vehicle 100 may transition the first controller 190-1 from the initialization state 510 to the pre-charge state 550. Here, the pre-charge state 550 may include the pre-charge process 552 that prepares the alternator 420 to generate electrical energy. Specifically, the first controller 190-1 may transmit one or more signals to the converters 122 to transition the converters 122 into the pre-charge mode. As such, electrical energy from the power distribution networks 120 (e.g., from the battery cells 128) may be supplied to the corresponding converters 122. The corresponding converters 122 may step up the battery voltage of the battery current to the pre-charge voltage of the pre-charge current. As such, the pre-charge current flows from the battery cells 128, through the converters 122, the output port 440 of the power generator 110, and/or the filter 430 of the power generator 110, into the alternator 420. The pre-charge voltage and/or the pre-charge current may be used “pre-excite” the alternator 420 for use in generating electricity as described above. In some aspects, the pre-charge voltage may be 20 V, 30 V, 40 V, 48 V, 50 V, or other voltages.

In some aspects, by using the pre-charge operations described above, the electrical system 102 may be simplified by obviating a need to use alternative devices for pre-charging the alternator 420 (e.g., no need to have a battery that supplies sufficient current/voltage for pre-charging). If the pre-charge process 552 is successful (e.g., the alternator 420 is able to generate a voltage at or above a predetermined threshold voltage, such as 40 V, 45 V, 48 V, 50 V, 55 V, or other threshold voltages), the first controller 190-1 may transition into a running state 570. If the pre-charge process 552 is unsuccessful (e.g., the alternator 420 is unable to generate a voltage at or above the predetermined threshold voltage), the first controller 190-1 may enter the pre-charge faulted step 554, and/or revert back to the initialization state 510 to restart the initialization process 512.

During the running state 570 of the first controller 190-1, if the running process 572 is successful, the alternator 420 may be ready to supply the alternator current 402 steadily to the electrical system 102. As such, the first controller 190-1 may transmit one or more signals to the converters 122 to toggle from the pre-charge mode (supplying pre-charge current/voltage to the alternator 420) to the buck mode (stepping down the output current 404 for use in the power distribution networks 120). If there is a voltage conversion fault, the electrical system 102 may enter into the voltage conversion faulted step 574. After the voltage conversion fault, the electrical system 102 may enter into the running faulted step 576, and/or revert back to the initialization state 510 to restart the initialization process 512.

In some aspects of the present disclosure, the first controller 190-1 and/or the electrical system 102 may return from any of the shore power state 530, the pre-charge state 550, and/or the running state 572 back to the initialization state 510 based on the input of the driver of the vehicle 100 (e.g., moving the key back to the first position).

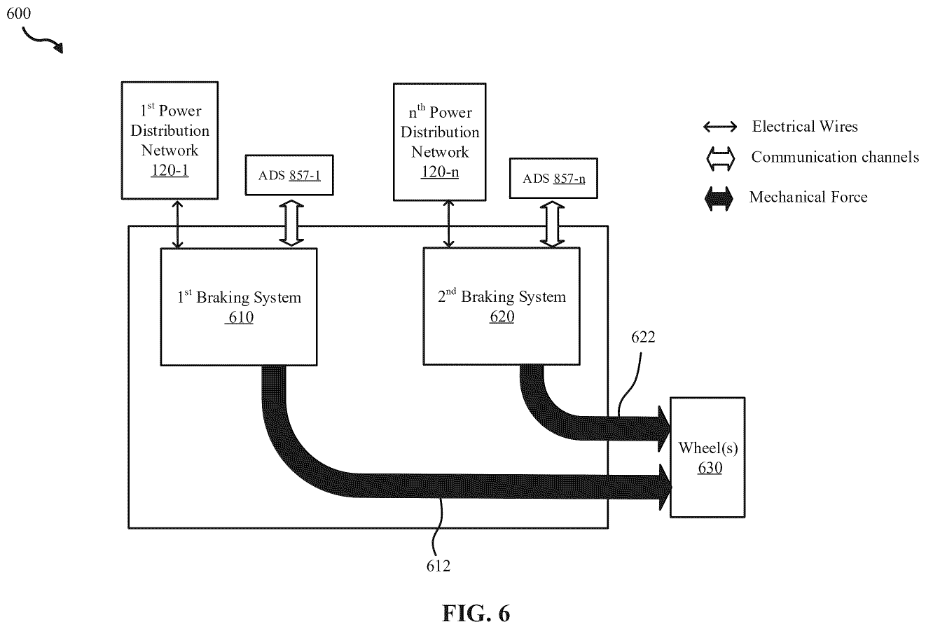

FIG. 6 is a block diagram of a backup braking system 600 having two or more independent braking systems to which power may be directed and/or re-directed when a degradation is identified, as described above, and according to various aspects of the present disclosure. The backup braking system 600 may include a first braking system 610 configured to slow or stop the vehicle 100. The backup braking system 600 may include a second braking system 620 configured to slow or stop the vehicle 100 either in combination with the first braking system 610 or independently, such as in response to a degradation of the first braking system 610. The backup braking system 600 may be one of the high integrity loads 126.

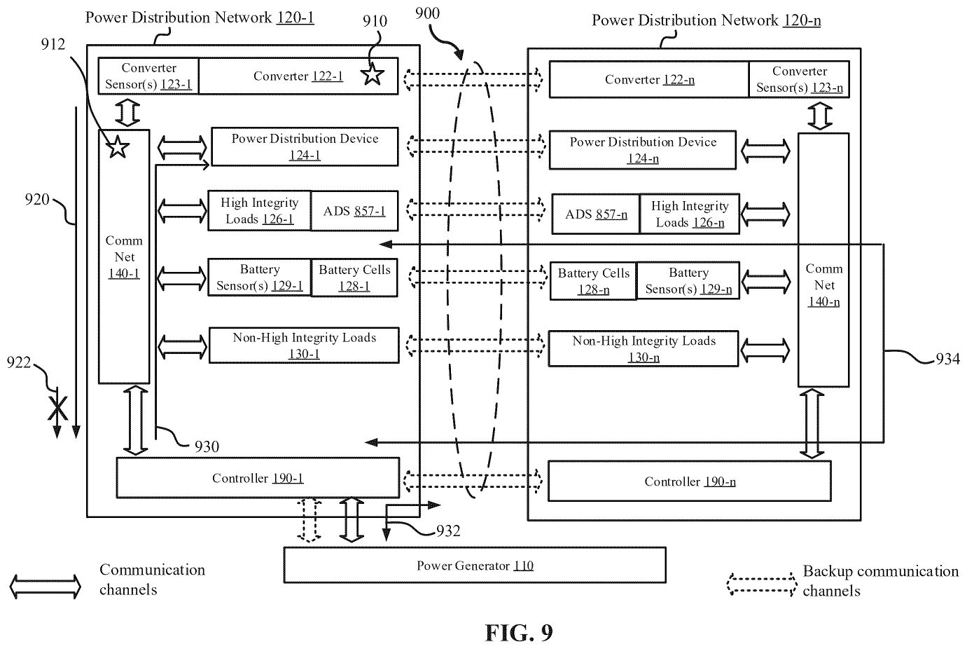

In some aspects of the present disclosure, the first braking system 610 may receive electrical energy and/or communication signals from the first power distribution network 120-1 and/or components of the first power distribution network 120-1. In one aspect, the first braking system 610 may receive electrical energy from the first power distribution network 120-1 and communication signals from a first ADS 857-1 (FIGS. 8 and 9). The second braking system 620 may receive electrical energy and/or communication signals from the n^{th} power distribution network 120-n and/or components of the n^{th} power distribution network 120-n. The second braking system 620 may receive electrical energy from the n^{th} power distribution network 120-n and communication signals from the n^{th} ADS 857-n (FIGS. 8 and 9). Here, the ADS 857 may be disposed within or outside of the respective power distribution network 120. As such, degradation in any portion of one of plurality of power distribution networks 120-1 . . . 120-n would not render the backup braking system 600 non-operational because one or more other of the plurality of power distribution networks 120-1 . . . 120-n may continue to operate the backup braking system 600.

In some aspects, the first braking system 610 and/or the second braking system 620 may be manually controlled by a driver and/or autonomously controlled a virtual driver. The first braking system 610 and/or the second braking system 620 may each include a pneumatic brake system. As such, in response to the first braking system 610 being activated (manually or autonomously), the first braking system 610 may apply a first pressure 612 (e.g., a pneumatic pressure and/or a physical pressure) to a braking device, e.g., calipers applying brake pads to a brake disc or rotor, to slow or stop one or more wheels 630. Additionally or alternatively, in response to the first braking system 610 failing and the second braking system 620 being activated (manually or autonomously), the second braking system 620 may apply a second pressure 622 (e.g., a pneumatic pressure and/or a physical pressure) to a different braking device, e.g., calipers applying brake pads to a brake disc or rotor, to slow or stop the one or more wheels 630.

In some aspects, the first braking system 610 may include an electro-hydraulic brake system and the second braking system 620 may include a pneumatic brake system. In an aspect, the first braking system 610 and the second braking system 620 may include electro-hydraulic brake systems. In certain aspect, the first braking system 610 and the second braking system 620 may include pneumatic brake systems. In some aspects, the first braking system 610 and the second braking system 620 may be configured to apply mechanical forces to the wheels 630 to reduce the speed of the vehicle 100. In one aspect, the first braking system 610 and the second braking system 620 may cause brake pads (not shown) to apply frictional forces to reduce the speed of the vehicle 100. Other mechanisms may also be used.

In some aspects, the vehicle 100 may include a backup electronic park brake system. The electronic park brake may independently control one or more braking systems, such as to enable proper parking of the vehicle 100. In case the main park brake becomes non-operational, the backup operational electronic park brake system may enable proper parking of the vehicle 100.

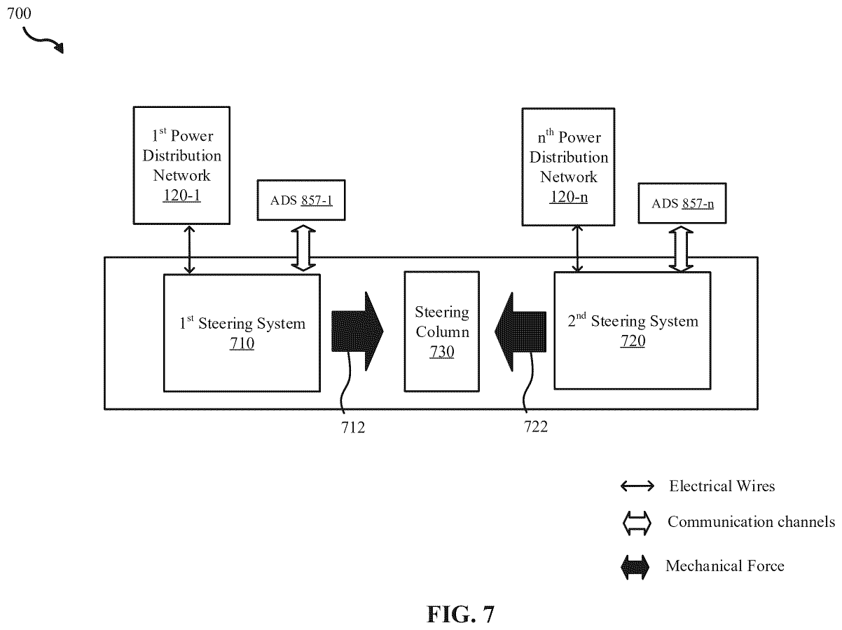

FIG. 7 is a block diagram of a backup steering system 700 having two or more independent steering systems to which power may be directed and/or re-directed when a degradation is identified, as described above, and according to aspects of the present disclosure. The backup steering system 700 may include a first steering system 710 configured to steer the vehicle 100. The backup steering system 700 may include a second steering system 720 configured to steer the vehicle 100. The first steering system 710 may apply a first force 712 to steer a steering column 730. The second steering system 720 may apply a second force 722 to steer the steering column 730. The first steering system 710 and the second steering system 720 may apply the first force 712 and the second force 722 in parallel to the steering column 730. In response to a degradation by one of the first steering system 710 or the second steering system 720, the other steering system may continue controlling the steering column 730. The backup steering system 700 may be one of the high integrity loads 126.

In some aspects of the present disclosure, the first steering system 710 may receive electrical energy and/or communication signals from the first power distribution network 120-1 and/or components of the first power distribution network 120-1. In one aspect, the first steering system 710 may receive electrical energy from the first power distribution network 120-1 and communication signals from the first ADS 857-1 (FIGS. 8 and 9). The second steering system 720 may receive electrical energy and/or communication signals from the n^{th} power distribution network 120-n and/or components of the n^{th} power distribution network 120-n. The second steering system 720 may receive electrical energy from the n^{th} power distribution network 120-n and communication signals from the n^{th} ADS 857-n (FIGS. 8 and 9). Here, the ADS 857 may be disposed within or outside of the respective power distribution network 120. As such, degradation in any portion of one of plurality of power distribution networks 120-1 . . . 120-n would not render the backup steering system 700 non-operational because one or more other of the plurality of power distribution networks 120-1 . . . 120-n may continue to operate the backup steering system 700.

In one aspect of the present disclosure, the backup steering system 700 may include two servo motors operationally controlled by a virtual driver (of autonomous vehicle system) for steering the vehicle 100 in various directions. In some aspects, the two servo motors may independently provide up to a certain torque to the steering column. The two servo motors may work together and provide a parallel redundancy. In an aspect, the two servo motors may work continuously sharing the driving load. If there is a problem with one of the servo motors, the other servo motor may take over to provide the control required to keep the vehicle 100 on a controlled trajectory. Alternatively, if power is lost to one of the servo motors, the other servo motor may take over. Parallel redundancy may reduce latency as compared to series redundancy.

In some aspects, for example, the vehicle 100 may be a vehicle, an electric vehicle, a hybrid vehicle, an semi-autonomous vehicle (a vehicle that operates autonomously, but can be overridden by a human operator), a fully autonomous vehicle (a vehicle that operates autonomously, and cannot be overridden by a human operator), an autonomous car, an autonomous bus, or an autonomous truck, a freight truck, a goods carrier, a class eight truck, a heavy-duty truck, a fleet truck, or a flatbed truck. The vehicle 100 may be configured to operate in an autonomous mode, e.g., without having a human driver controlling the vehicle 100.

In an aspect of the present disclosure, the vehicle 100 may be designed to comply with the ISO standards to provide an operational system with no single point of degradation (e.g., degradation above a predetermined threshold) with an autonomous driving system (ADS) or a self-driving system (SDS). This may be achieved by controlling each component within the vehicle 100 from the ADS/SDS, providing continuous degradation monitoring, and/or reporting to the ADS/SDS. As used herein, “Automated Driving System (ADS)” or “Self-Driving System (SDS)” refers to a completely automated driving system or at least a level 4 autonomous system enabling vehicles to navigate and operate without human input. ADS or SDS operates based on collecting data from sensors such as, but not limited to, cameras, radar, and lidar to perceive their surroundings and build a real-time picture of the road, including other vehicles, pedestrians, traffic lights, and lane markings. The ADS/SDS may include a software based controller such as, not limited to an autonomous driving computer (ADC) for processing the sensor data to make navigation decisions on the road considering factors like traffic rules, road signs, and objects detected around the vehicle. The software controller also uses a detailed high-resolution map to enable the vehicle to localize itself and plan its route.

In certain aspects, the vehicle 100 may be a petrol fueled vehicle, and/or include an internal combustion engine as a propulsion system, an associated power train, and/or power transmission. In some aspects, the vehicle 100 may be a diesel fueled vehicle with an internal combustion engine and a diesel power train. For example, the vehicle 100 may include a Detroit® diesel engine with a Detroit® power train having a Detroit® power transmission. In another aspect, the vehicle 100 may be a vehicle with an electric power train. In alternative aspects, the vehicle may be propelled by hydrogen (e.g., H₂ internal combustion engine, fuel cell electric vehicle (FCEV), etc.).

In a further aspect, the vehicle 100 may be any combination of an electric-powered vehicle, a petrol-powered vehicle, a diesel-powered vehicle, and/or a hydrogen-powered vehicle.

FIG. 8 illustrates an example of the controller 190 according to various aspects of the present disclosure. The controller 190 may be in a single package or as a chip set assembly with multiple components. The controller 190 may be implemented as a single integrated circuit device, or a number of distributed circuit devices. In one aspect, the controller 190 may include one or more processors 810 configured to execute instructions stored in one or more memories 820. The one or more memories 820 may include computer executable instructions that implement various functions of the current disclosure.

The term “processor” as used herein can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims.

The controller 190 may include an interface circuit 822 configured to provide a hardware interface with external devices. The controller 190 may include a communication circuit 824 configured to communicate via wired or wireless communication channels. The controller 190 may include a storage 826 configured to store digital information. The controller 190 may include an input/output (I/O) interface device 828 configured to receive input signals and/or transmit output signals. The controller 190 may include a security circuit 830 configured to authenticate an identity, authenticate a token, manage security keys, encryption keys, and/or decryption keys, encrypt data, and/or decrypt data according to aspects of the present disclosure.

In one aspect, the security circuit 830 may receive a security token (not shown) from an external device. The security circuit 830 may determine whether the external device is a trusted device by authenticating the security token. If authenticated, the security circuit 830 may grant the external device one or more of read privilege (the external device is able to read data in the storage 826), write privilege (the external device is able to modify data in the storage 826 and/or update firmware in the one or more memories 820), or both. The controller 190 may include a bus 832 configured to provide connections among the subcomponents of the controller 190.

In one aspect of the present disclosure, the one or more processors 810 may execute instructions stored in the one or more memories 820 to implement a power generator ECU 850. The power generator ECU 850 may be configured to perform the functions of the power generator 110 described above.

In one aspect of the present disclosure, the one or more processors 810 may execute instructions stored in the one or more memories 820 to implement one or more power distribution ECUs 852. The one or more power distribution ECUs 852 may be configured to the perform functions of the power distribution devices 124 described above.

In one aspect of the present disclosure, the one or more processors 810 may execute instructions stored in the one or more memories 820 to implement one or more converter ECUs 854. The one or more converter ECUs 854 may be configured to perform the functions of the converters 120 described above.

In one aspect of the present disclosure, the one or more processors 810 may execute instructions stored in the one or more memories 820 to implement one or more battery ECUs 856. The one or more battery ECUs 856 may be configured to the perform functions for managing the battery cells 128 as described above.

In certain aspects of the present disclosure, the one or more processors 810 may execute instructions stored in the one or more memories 820 to implement one or more ADS 857. The ADS may include the one or more brake system ECUs 858 and/or the one or more steering system ECUs 860. The ADS 857 may be configured to operate, autonomously and/or semi-autonomously, the vehicle 100. In some instances, the ADS 857 may include other ECUs for the operation of the vehicle 100 (e.g., lidar, sensors, virtual drivers, etc.).

In one aspect of the present disclosure, the one or more processors 810 may execute instructions stored in the one or more memories 820 to implement one or more brake system ECUs 858. The one or more brake system ECUs 858 may be configured to the perform functions associated with controlling the backup braking system 500 as described above.

In one aspect of the present disclosure, the one or more processors 810 may execute instructions stored in the one or more memories 820 to implement one or more steering system ECUs 860. The one or more steering system ECUs 860 may be configured to the perform functions for controlling the backup steering system 600 as described above.

In one aspect of the present disclosure, the one or more processors 810 may execute instructions stored in the one or more memories 820 to implement one or more network ECUs 862. The one or more network ECUs 862 may be configured to the perform functions for managing the communication networks 140-1 . . . 140-n as described above.

In certain aspects of the present disclosure, the one or more processors 810 may execute instructions stored in the one or more memories 820 to implement one or more degradation detectors 864. The one or more degradation detectors 864 may be configured to identify one or more degradations in the electrical system 102, determining a countermeasure in response to identifying the one or more degradations, and/or providing an indication of the one or more degradations. Here, the one or more degradation detectors 864 are shown as a part of the one or more power distribution ECUs 852. However, the one or more degradation detectors 864 may be implemented differently according to various aspects of the present disclosure.

FIG. 9 is a block diagram showing communication networks in the electrical system 102 of the autonomous vehicle 100 and different signals according to various aspects of the present disclosure. In FIG. 9, a single power distribution network is shown for simplicity but one or more power distribution networks 120 may be implemented. Here, the controller 190 may communicate with the components of the power distribution network 120 via the communication network 140 and/or the communication channels. In some aspects, in response to one or more degradations in the communication network 140 and/or the communication channels, the controller 190 may communicate with the power distribution network 120 and/or the power generator 110 via the backup communication network 900 and/or the backup communication channels.

In certain aspects of the present disclosure, a degradation 910 may occur in the converter 122. One or more converter sensors 123 may detect the degradation 910 in the converter 122. For example, the one or more converter sensors 123 may detect an open circuit in the converter 122. As a result, the converter 122 may be unable to properly supply electrical energy to the components of the power distribution network 120. The one or more sensors 123 may transmit a degradation indication signal 920 via the communication network 140 to the controller 190 indicating the degradation 910. Upon receiving the degradation indication signal 920, the controller 290 may identify a degradation, such as the degradation 910, in the converter 122. In response to the degradation 910 in the converter 122 (as indicated by the degradation indication signal 920), the controller 190 may transmit a degradation response signal 930 to the power distribution device 124. The degradation response signal 930 may indicate to the power distribution device 124 that the converter 122 is inoperable. In response to the degradation response signal 930, the power distribution device 124 may direct the electrical energy in the battery cells 128 to the high integrity loads 126 to ensure the proper operation of the vehicle 100.

In another aspect of the present disclosure, a degradation 912 may occur in the communication network 140. As a result, the communication network 140 may fail to transmit periodic status signals 922 to the controller 190. The periodic status signals 922 may be a plurality of signals that are transmitted periodically by the communication network 140 to the controller 190 indicating the proper operation of the communication network 140. If the controller 190 is receiving the periodic status signals 922, the controller 190 will assume that the communication network 140 is operating properly. If the controller 190 fails to receive one or more of the periodic status signals 922, the controller 190 will assume that the communication network 140 has experienced a degradation, such as the degradation 912.

As a result of failing to receive one or more of the periodic status signals 922, the controller 190 may identify a degradation, such as the degradation 912, in the communication network 140. In response, the controller 190 may transmit one or more degradation response signals 932 to the backup communication network 900, the power generator 110, and/or components of the power distribution network 120. The one or more degradation response signals 932 may indicate to the backup communication network 900, the power generator 110, and/or components of the power distribution network 120 that the communication network 140 has degraded due to the degradation 912. As such, the backup communication network 900 may be used for communication.

In certain aspects of the present disclosure, the controller 190 may provide an indication (such as displaying a warning light) to the operator (not shown) of the vehicle 100 in response to the detection of a degradation, such as the degradations 910, 912. Additionally, the indication (or a related indication) provided by the controller 190 may indicate the type of degradation.

In one aspect of the present disclosure, the degradation 912 in the communication network 140-1 may prevent the controller 190-1 from communicating (e.g., transmitting or receiving a signal) with the ADS 857-1 associated with the high integrity loads 126-1. In response to the degradation 912, the controller 190-1 may communicate with the ADS 857-1 via a backup path 934. For example, the controller 190-1 may transmit one or more signals to the controller 190-n, which relays the one or more signals to the ADS 857-n. The ADS 857-n may relay the one or more signals to the ADS 857-1 via the backup communication network 900 and/or the backup communication channels.

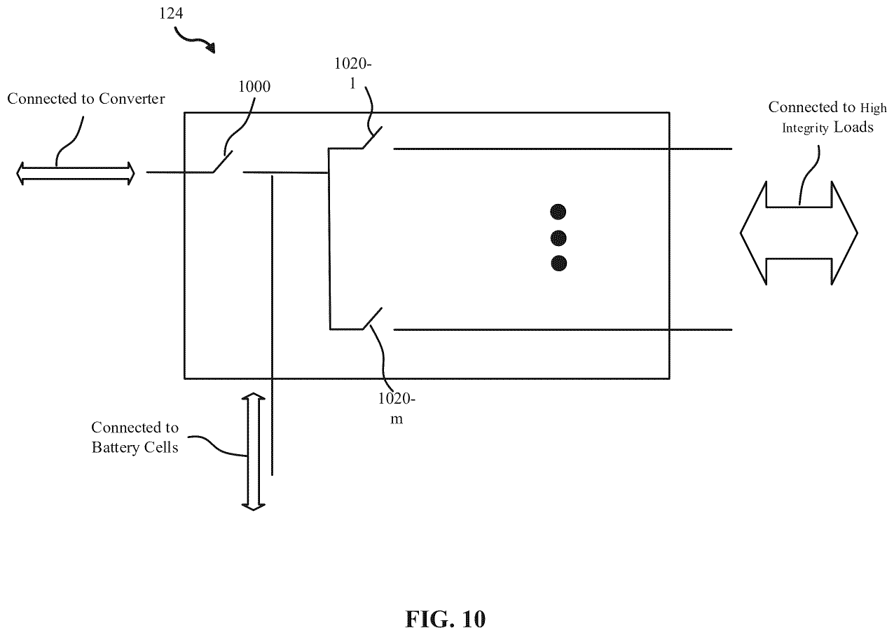

FIG. 10 is a block diagram of a power distribution device 124 according to aspects of the present disclosure. Referring to FIGS. 1-4, 7, and 8, in some aspects, electrical energy from the power generator 110 may be supplied to the converter 122, and through a switch 1000, supplied to the power distribution device 124. The controller 190 may close the switch 1000 of the power distribution device 124 to enable the power distribution device 124 to receive the electrical energy from the converter 122, such as in the form of the one or more supplied currents. In one aspect, the controller 190 may close the switch 1000 to supply a portion of the electrical energy to the battery cells 128 and/to charge the battery cells 128. In other aspects, the controller 190 may close a plurality of switches 1020-1 . . . 1020-m to supply another portion of the electrical energy to the high integrity loads 126. Here, each of the plurality of switches 1020-1 . . . 1020-m may control the flow of electricity between the converter 122 and/or the battery cells 128 to a corresponding system of the systems 210-1 . . . 210-m in the high integrity loads 126.

In some aspects, the controller 190 may detect a degradation, such as the degradation 910 associated with the converter 122. To isolate the high integrity loads 126 and the battery cells 128, the controller 190 may open the switch 1000 and close the plurality of switches 1020-1 . . . 1020-m to direct the electrical energy stored in the battery cells 128 to the high integrity loads 126. Further, opening the switch 1000 may isolate the battery cells 128 from components other than the high integrity loads 126. As such, this scheme prevents the electrical energy stored in the battery cells 128 from “leaking” charges. Additionally or alternatively, opening the switch 1000 may prevent the battery cells 128 and the high integrity loads 126 from being exposed to the degradation.

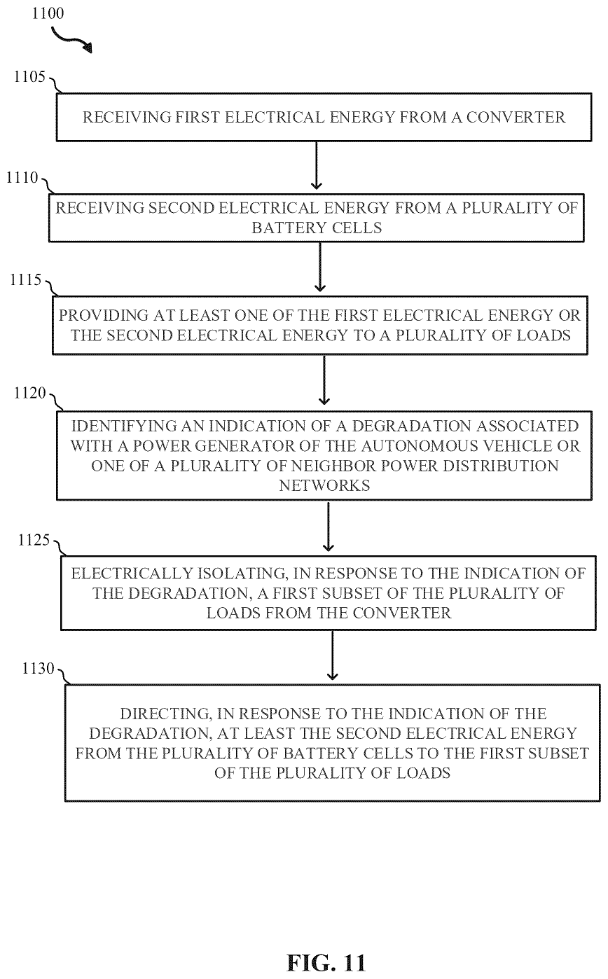

FIG. 11 is a flow chart showing a method 1100 for operating a power distribution device, such as in the vehicle 100, according to aspects of the present disclosure. The method 1100 may be performed by one or more of the power distribution devices 124-1 . . . 124-n, one or more of the plurality of controllers 190-1 . . . 190-n, and/or components of the one or more of the plurality of controllers 190-1 . . . 190-n.

At 1105, the method 1100 may include receiving first electrical energy from a converter. For example, as described in detail above, the power distribution device 124 may be configured to, and/or provide means for, receiving first electrical energy (e.g., the current 306) from the converter 122.

At 1110, the method 1100 may include receiving second electrical energy from a plurality of battery cells. For example, as described in detail above, the power distribution device 124 may be configured to, and/or provide means for, receiving second electrical energy (e.g., stored current 318) from a plurality of battery cells 128.

At 1115, the method 1100 may include providing at least one of the first electrical energy or the second electrical energy to a plurality of loads. For example, as described in detail above, the power distribution device 124 may be configured to, and/or provide means for, providing at least one of the first electrical energy (e.g., current 306) or the second electrical energy (e.g., the stored current 318) to a plurality of loads (e.g., the high integrity loads 126 and/or the non-high integrity loads 130).

At 1120, the method 1100 may include identifying an indication of a degradation associated with a power generator of the autonomous vehicle or one of a plurality of neighbor power distribution networks. For example, as described in detail above, the power distribution device 124 may be configured to, and/or provide means for, identifying an indication (e.g., the degradation indication signal 920 and/or failing to receive the periodic status signals 922) of a degradation (e.g., the degradations 910, 912) associated with a power generator 110 of the autonomous vehicle 110 or one of a plurality of neighbor power distribution networks 120-1 to 120-n. In one example, the power distribution ECU 852, the degradation detector 864, the controller 190, and/or the power distribution device 124 may receive the degradation indication signal 920 and/or failing to receive the periodic status signals 922. As such, the power distribution ECU 852, the degradation detector 864, the controller 190, and/or the power distribution device 124 may identify the degradations 910, 912.

At 1125, the method 1100 may include electrically isolating, in response to the indication of the degradation, a first subset of the plurality of loads from the converter. For example, as described in detail above, the power distribution device 124 may be configured to, and/or provide means for, electrically isolating (e.g., via the switch 1000), in response to the indication (e.g., the degradation indication signal 920 and/or failing to receive the periodic status signals 922) of the degradation (e.g., the degradations 910, 912), a first subset of the plurality of loads (e.g., one or more of the systems 210-1 . . . 210-m of the high integrity loads 126) from the converter (e.g., the converter 122). In one example, the power distribution ECU 852, the degradation detector 864, the controller 190, and/or the power distribution device 124 may open the switch 1000 to isolate the ono or more of the systems 210-1 . . . 210-m from the converter 122.

At 1130, the method 1100 may include directing, in response to the indication of the degradation, at least the second electrical energy from the plurality of battery cells to the first subset of the plurality of loads. For example, as described in detail above, the power distribution device 124 may be configured to, and/or provide means for, directing (e.g., by opening the switch 1000 and closing the plurality of switches 1020-1 . . . 1020-m), in response to the indication of the degradation, at least the second electrical energy (e.g., stored current 318) from the plurality of battery cells 128 to the first subset of the plurality of loads (e.g., at least one of the high integrity loads 126). In one example, the power distribution ECU 852, the degradation detector 864, the controller 190, and/or the power distribution device 124 may close the plurality of switches 1020-1 . . . 1020-m to direct the stored current 318 from the battery cells 128 to the high integrity loads 126.

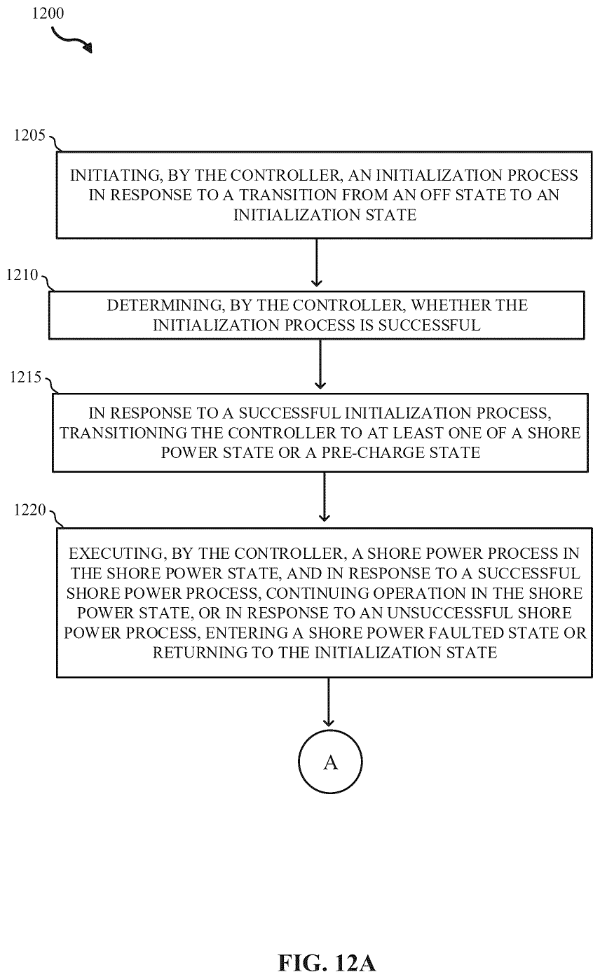

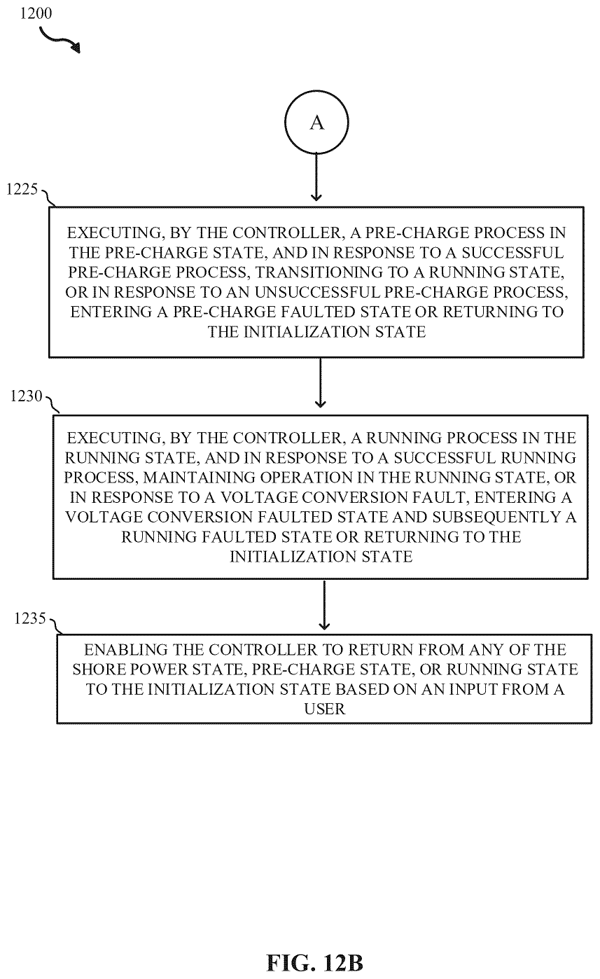

FIGS. 12A-B are a flow chart showing a method 1200 for operating a controller of an electrical system on an autonomous vehicle. The method 1200 may be performed by one or more of the power distribution devices 124-1 . . . 124-n, one or more of the plurality of controllers 190-1 . . . 190-n, and/or components of the one or more of the plurality of controllers 190-1 . . . 190-n.

At 1205, the method 1200 may initiate, by the controller, an initialization process in response to a transition from an off state to an initialization state. For example, the first controller 190-1 may be configured to, and/or provide means for, initiating the initialization process 512 in response to a transition from the off state 502 to the initialization state 510. The first controller 190-1 may receive indications (e.g., insertion of car key) that indicates the transition.

At 1210, the method 1200 may determine, by the controller, whether the initialization process is successful. For example, the first controller 190-1 may be configured to, and/or provide means for, determining whether the initialization process 512 is successful.

At 1215, the method 1200 may, in response to a successful initialization process, transition the controller to at least one of a shore power state or a pre-charge state. For example, the first controller 190-1 may be configured to, and/or provide means for, transitioning the first controller 190-1 to the shore power state 530 or the pre-charge state 550 in response to successfully completing the initialization process 512.

At 1220, the method 1200 may execute, by the controller, a shore power process in the shore power state, and in response to a successful shore power process, continuing operation in the shore power state, or in response to an unsuccessful shore power process, entering a shore power faulted state or returning to the initialization state. For example, the first controller 190-1 may be configured to, and/or provide means for, executing the shore power process 532 or enter the shore power faulted state 534. During the shore power process 532, the first controller 190-1 may receive signals from one or more voltage sensors to determine the volage bands 460 of the input voltage of the input current 401. Based on the input voltage (e.g., 12 V, 24 V, 36 V, 48 V, or other voltages), the first controller 190-1 may determine how to distribute the input current 401 within the electrical system 102 as described above. If the shore power process 532 is not successful, the first controller 190-1 may enter the shore power faulted state 534 and/or re-initialized.

At 1225, the method 1200 may execute, by the controller, a pre-charge process in the pre-charge state, and in response to a successful pre-charge process, transitioning to a running state, or in response to an unsuccessful pre-charge process, entering a pre-charge faulted state or returning to the initialization state. For example, the first controller 190-1 may be configured to, and/or provide means for, executing the pre-charge process 552 or enter the pre-charge faulted state 554. During the pre-charge process 552, the first controller 190-1 may transmit signals to the converters 122-1 . . . 122-n to operate in the pre-charge mode. As such, a pre-charge current and/or voltage may be supplied to the alternator 420 to pre-excite the alternator 420. If the shore power process 532 is successful (i.e., the alternator 420 is able to output sufficient voltage, such as 48 V), the alternator 420 will continue to supply electricity to the electrical system 102. If the pre-charge process 552 is not successful, the first controller 190-1 may enter the pre-charge faulted state 554 and/or re-initialized.

At 1230, the method 1200 may execute, by the controller, a running process in the running state, and in response to a successful running process, maintaining operation in the running state, or in response to a voltage conversion fault, entering a voltage conversion faulted state and subsequently a running faulted state or returning to the initialization state. For example, the first controller 190-1 may be configured to, and/or provide means for, executing, by the first controller 190-1, the running process 572 in the running state 570, and in response to a successful running process 572, maintaining operation in the running state 570, or in response to a voltage conversion fault, entering the voltage conversion faulted state 574 and subsequently the running faulted state 576 or returning to the initialization state 510.

At 1235, the method 1200 may enable the controller to return from any of the shore power state, pre-charge state, or running state to the initialization state based on an input from a user. For example, the first controller 190-1 may be configured to, and/or provide means for, enabling the first controller 190-1 to return from any of the shore power state 530, the pre-charge state 550, or running state 570 to the initialization state 510 based on an input from the driver of the vehicle 100.

Aspects of the present disclosure include a method for operating a power distribution device during a degradation including receiving first electrical energy from a converter, receiving second electrical energy from a plurality of battery cells, providing at least one of the first electrical energy or the second electrical energy to a plurality of loads, identifying an indication of a degradation associated with a power generator of the autonomous vehicle or one of a plurality of neighbor power distribution networks, electrically isolating, in response to the indication of the degradation, a first subset of the plurality of loads from the converter, and directing, in response to the indication of the degradation, at least the second electrical energy from the plurality of battery cells to the first subset of the plurality of loads.

Aspects of the present disclosure include the method above, further comprising suspending supply of the second electrical energy to a second subset of the plurality of loads.

Aspects of the present disclosure include any of the methods above, wherein the first subset of the plurality of loads includes high integrity loads and the second subset of the plurality of loads includes non-high integrity loads.

Aspects of the present disclosure include any of the methods above, wherein the power generator comprises an alternator configured to output an alternator current and a filter configured to filter the alternator current to generate an output current to provide the first electrical energy.

Aspects of the present disclosure include any of the methods above, wherein the second voltage is lower than the first voltage.

Aspects of the present disclosure include any of the methods above, wherein each of the plurality of power distribution networks further comprises a communication network configured to provide one or more communication channels for receiving the indication of the degradation.

Aspects of the present disclosure include any of the methods above, wherein the power distribution device comprises a plurality of sensors, wherein at least one of the plurality of sensors is configured to detect the degradation.

Aspects of the present disclosure may include a method for operating a controller to charge a vehicle including initiating, by the controller, an initialization process in response to a transition from an off state to an initialization state, determining, by the controller, whether the initialization process is successful, in response to a successful initialization process, transitioning the controller to at least one of a shore power state or a pre-charge state, executing, by the controller, a shore power process in the shore power state, and in response to a successful shore power process, continuing operation in the shore power state, or in response to an unsuccessful shore power process, entering a shore power faulted state or returning to the initialization state, executing, by the controller, a pre-charge process in the pre-charge state, and in response to a successful pre-charge process, transitioning to a running state, or in response to an unsuccessful pre-charge process, entering a pre-charge faulted state or returning to the initialization state, executing, by the controller, a running process in the running state, and in response to a successful running process, maintaining operation in the running state, or in response to a voltage conversion fault, entering a voltage conversion faulted state and subsequently a running faulted state or returning to the initialization state, and enabling the controller to return from any of the shore power state, pre-charge state, or running state to the initialization state based on an input from a user.

Aspects of the present disclosure include the method above, further comprising, in response to an unsuccessful initialization process, entering an initialization faulted state and attempting the initialization process again.

Aspects of the present disclosure include any of the methods above, wherein the pre-charge process comprises transmitting, by the controller, one or more signals to a converter to transition the converter into a pre-charge mode, such that electrical energy from a battery is supplied to an alternator to pre-excite the alternator for generating electrical energy.

Aspects of the present disclosure include any of the methods above, further comprising, in response to detecting an overvoltage or undervoltage condition during the shore power process, entering a shore power faulted state and taking corrective action including notifying a user or suspending input current.

Aspects of the present disclosure include any of the methods above, wherein the running process comprises transmitting, by the controller, one or more signals to a converter to toggle from a pre-charge mode to a buck mode for stepping down output current for use in a power distribution network.

Aspects of the present disclosure include any of the methods above, further comprising, in response to a voltage conversion fault during the running process, entering a voltage conversion faulted state and subsequently a running faulted state, and reverting to the initialization state to restart the initialization process.

Aspects of the present disclosure include any of the methods above, further comprising, after entering any of the shore power state, pre-charge state, or running state, returning to the initialization state in response to a user input.

Aspects of the present disclosure include any of the methods above, wherein the controller is configured to transition between a plurality of operational states including off, initialization, shore power, pre-charge, and running, based on detected system conditions and user input.

Aspects of the present disclosure include any of the methods above, further comprising, in response to a fault detected in any of the shore power, pre-charge, or running states, automatically reverting to the initialization state to attempt system recovery.

Aspects of the present disclosure include any of the methods above, wherein the controller is configured to execute a bootloader during the initialization process prior to entering the shore power or pre-charge states.

Aspects of the present disclosure include any of the methods above, further comprising, in response to a successful pre-charge process, transitioning the controller to a running state in which the alternator supplies electrical energy to the power distribution network.

The above disclosure may include definitions having various examples and/or forms of components that fall within the scope of a term and that may be used for implementation. The examples are not intended to be limiting.

Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the term “example” does not limit the herein described subject matter. In addition, any aspect or design described herein as an “example” is not necessarily preferred or advantageous over other aspects or designs, nor does it preclude equivalent exemplary structures and techniques known to those of ordinary skill in the art.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the aspects described herein are, for example, capable of operation in sequences other than those illustrated or otherwise described herein.

Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

No element, act, or instruction used herein should be construed as critical or essential unless explicitly described as such. Furthermore, as used herein, the term “set” or “plurality” is intended to include items (e.g., related items, unrelated items, a combination of related items, and unrelated items, etc.), and may be used interchangeably with “one or more.” Further, the phrase “based on” is intended to mean “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As defined herein, “approximately” can, in some aspects, mean within plus or minus ten percent of the stated value. In other aspects, “approximately” can mean within plus or minus five percent of the stated value. In further aspects, “approximately” can mean within plus or minus three percent of the stated value. In yet other aspects, “approximately” can mean within plus or minus one percent of the stated value.

As used herein, the term “component” broadly construes hardware, firmware, and/or a combination of hardware, firmware, and software.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. An electrical system of a vehicle, comprising:
a power generator configured to provide first electrical energy; and
a plurality of power distribution networks configured to receive the first electrical energy, wherein each of the plurality of power distribution networks includes:
a converter configured to convert a portion of the first electrical energy at a first voltage to second electrical energy at a second voltage;
a plurality of battery cells configured to provide third electrical energy;
a plurality of loads configured to receive at least the second electrical energy or the third electrical energy; and
a power distribution device configured to:
identify an indication of a degradation associated with the power generator or one of the plurality of power distribution networks;
electrically isolate, in response to the indication of the degradation, a first subset of the plurality of loads from the converter; and
direct, in response to the indication of the degradation, the third electrical energy from the plurality of battery cells to the first subset of the plurality of loads.

2. The electrical system of claim 1, wherein the power distribution device is further configured to, in response to the indication of the degradation, suspend supply of the third electrical energy to a second subset of the plurality of loads by opening one or more switches between the plurality of battery cells and the second subset of the plurality of loads.

3. The electrical system of claim 2, wherein the first subset of the plurality of loads includes high integrity loads and the second subset of the plurality of loads includes non-high integrity loads.

4. The electrical system of claim 1, wherein the power generator comprises:
an alternator configured to output an alternator current; and
a filter configured to filter the alternator current to generate an output current to provide the first electrical energy.

5. The electrical system of claim 1, wherein the second voltage is lower than the first voltage.

6. The electrical system of claim 1, further comprising a plurality of sensors, wherein at least one of the plurality of sensors is configured to detect the degradation.

7. The electrical system of claim 1, wherein each of the plurality of power distribution networks further comprises a communication network configured to provide one or more communication channels for receiving the indication of the degradation.

8. An electrical system of a vehicle, comprising:
a power generator configured to provide first electrical energy;
a plurality of power distribution networks configured to receive the first electrical energy, wherein each of the plurality of power distribution networks includes:
a converter configured to convert a portion of the first electrical energy at a first voltage to second electrical energy at a second voltage;
a plurality of battery cells configured to provide third electrical energy;
a plurality of loads configured to receive at least the second electrical energy or the third electrical energy; and
a power distribution device configured to control flows of electrical energy within the corresponding power distribution network; and
a controller configured to:
identify an indication of a degradation associated with the power generator or one of the plurality of power distribution networks;
cause the power distribution device to electrically isolate, in response to the indication of the degradation, a first subset of the plurality of loads from the converter; and
cause the power distribution device to direct, in response to the indication of the degradation, at least the third electrical energy from the plurality of battery cells to the first subset of the plurality of loads.

9. The electrical system of claim 8, wherein the controller is further configured to transmit a signal, in response to the indication of the degradation, to open one or more switches to cause the power distribution device to suspend supply of the third electrical energy to a second subset of the plurality of loads.

10. The electrical system of claim 9, wherein the first subset of the plurality of loads includes high integrity loads and the second subset of the plurality of loads includes non-high integrity loads.

11. The electrical system of claim 10, wherein the high integrity loads include one or more of a backup steering system or a backup braking system.

12. The electrical system of claim 8, wherein the power generator comprises:
an alternator configured to output an alternator current; and
a filter configured to filter the alternator current to generate an output current to provide the first electrical energy.

13. The electrical system of claim 8, wherein the second voltage is lower than the first voltage.

14. The electrical system of claim 9, further comprising a plurality of sensors, wherein at least one of the plurality of sensors is configured to detect the degradation.

15. The electrical system of claim 14, wherein the controller is further configured to identify the indication of the degradation by receiving a signal from at least one of the plurality of sensors indicating the degradation.

16. The electrical system of claim 8, wherein the controller is further configured to identify the indication of the degradation by failing to receive a status signal from an electronic control unit associated with the power generator or one of the plurality of power distribution networks.

17. The electrical system of claim 8, wherein each of the plurality of power distribution networks further comprises a communication network configured to provide one or more communication channels for receiving the indication of the degradation.

18. A method for operating a power distribution device of a power distribution network in a vehicle, comprising:
receiving first electrical energy from a converter;
receiving second electrical energy from a plurality of battery cells;
providing at least one of the first electrical energy or the second electrical energy to a plurality of loads;
identifying an indication of a degradation associated with a power generator of the vehicle or one of a plurality of neighbor power distribution networks;
electrically isolating, in response to the indication of the degradation, a first subset of the plurality of loads from the converter; and
directing, in response to the indication of the degradation, at least the second electrical energy from the plurality of battery cells to the first subset of the plurality of loads.

19. The method of claim 18, further comprising suspending supply of the second electrical energy to a second subset of the plurality of loads.

20. The method of claim 19, wherein the first subset of the plurality of loads includes high integrity loads and the second subset of the plurality of loads includes non-high integrity loads.
